(19) United States
(12) Patent Application Publication
(10) Pub. No.: US 2007/0260357 A1
(43) Pub. Date: Nov. 8, 2007

(54) Method for the Production of Hydrophilic Polymers and Finishing Products Containing the Same Using a Computer-Generated Model

(76) Inventors: Jorg Issberner, Willich-Neersen (DE); Jorg Resch, Duisburg (DE); Harald Schmidt, Tonisvorst (DE)

Correspondence Address: SMITH MOORE LLP, P.O. BOX 21927, GREENSBORO, NC, 27420, US

(21) Appl. No.: 11/570,165

(22) PCT Filed: Jun. 9, 2005
(86) PCT No.: PCT/EP05/06214

§ 371 Date: May 2, 2007

(30) Foreign Application Priority Data
Jun. 9, 2004 (DE) 10 2004 028 002.9

(51) Int. Cl. G06G 7/58; G05B 21/00

(52) U.S. Cl. 700/269; 703/12

(57) ABSTRACT

The invention relates generally to a process for producing a hydrophilic polymer, a prediction process, hygiene articles, and other chemical products, which comprise a hydrophilic polymer produced according to the process according to the invention, as well as the use of a polymer according to the invention in hygiene articles and further chemical products and the use of a computer-generated model for determination of different values and a process for production of hydrophilic polymer-comprising further processing products.

This application is a national stage application under 35 U.S.C. 371 of international application No. PCT/EP2005/006214 filed Jun. 9, 2005, and claims priority to German Application No. DE 10 2004 028 002.9 filed Jun. 9, 2004, the disclosures of which are expressly incorporated herein by reference.

### BACKGROUND OF THE INVENTION

The invention relates in general to a process for producing a hydrophilic polymer, a prediction process, hygiene articles and other chemical products which comprise a hydrophilic polymer produced according to the process according to the invention, as well as the use of a polymer according to the invention in hygiene articles, and further chemical products, and the use of a computer-generated model for determining different parameters, and a process for the production of further processing products comprising hydrophilic polymer. Further details are given in the following.

The use of neuronal networks in the production of bulk polymers is described in DE 698 01 508 T2. Here, a network of this type is described for control of the discontinuous polymerization of polyvinylchloride (PVC) in a reactor. A particular strength is in the temperature development.

PVC is a linear chain polymer with a simple structure, whose properties can be controlled substantially by the chain length and the chain length distribution, thus by the amount of initiator and monomer—as is common for chain polymers—according to the “root-I-law” and its further developments (Principles of Polymerization, Georg Odian, John Wiley and Sons, 2^{nd} Edition, 1981, page 179 ff.).

In contrast to these comparably simple chain polymers, crosslinked polymers are substantially more complex systems. The prediction of the cause-effect relation between the educts, the polymerization and processing conditions and the physical and chemical properties is substantially more difficult than for simple chain polymers.

A further increased degree of complexity compared to merely crosslinked polymers is shown in general by crosslinked polymers whose repeat units further comprise additional functionalities, such as charge-bearing functional groups.

A further increase of the complexity of the polymers can arise in that the material described in the above paragraph is refined by a further treatment, such as by reaction with additives, additionally in the morphology, for example to form a core-shell structure.

Of great industrial interest from the group of such complex polymers, besides ion exchange resins are above all hydrophilic polymers, also named superabsorbers (SAP), as described inter alia in Modern Superabsorbent Polymer Technology, F L Buchholz, G T Graham, Wiley-VCH, 1998. These are preferably lightly crosslinked, partially neutralized polyacrylates. The complexity of the hydrophilic polymers is increased in that they are not pure polymers, but rather compositions of a polymer and further materials which have a significant influence on the properties of this composition. Thus, for example, a core-shell structure can be obtained by a post-crosslinking. Thus it often does not depend only upon the carrying out of the polymerization as such; processing, refining and confectioning steps are also significant.

In contrast to the hydrophobic chain polymers, these crosslinked hydrophilic polymers, which form gels with water are used in many applications, for which these polymers must have a made-to-measure specification profile. Because of the complexity of the cause-effect-relationships for hydrophilic polymers between educt, polymerization-, refining-, confectioning- and processing conditions on the one hand, and the property profile of these polymers on the other hand, a transfer of a recipe which fulfils a desired specification profile on the laboratory scale is not automatically possible on the scale-up or production scale. Rather more, generally an array of further scale-up and laboratory experiments as well as so-called “up scale experiments” must be carried out, until a recipe also gives a hydrophilic polymer on the production scale which corresponds to the property profile achieved on the laboratory scale.

In addition, the degree of complexity of the demands of these hydrophilic polymers is increased through their further processing. Thus the properties of these polymers have a significant influence upon the further processing as such and the therefrom-arising further processing products. Examples of such further processings are spin, paper, absorbent layer, and diaper machines, which produce absorbent-capable and water- or aqueous liquid-absorbing fibers or fiber matrices, paper, absorbent layers, also named “cores”, and diapers. The degree of complexity is then also increased, if these hydrophilic polymers are combined with further components. Thus, in fiber and fiber matrix production, besides the hydrophilic polymer, further materials such as fibers or adhesives or glues can be used. In the formation of cores, besides the hydrophilic polymer, for example further layers such as tissue inserts, acquisition sheets and the like can be present, which contribute in collaboration with the hydrophilic polymer to an improved liquid management. For the improvement of the liquid management of the further processing products, the properties of the hydrophilic polymers interact with the properties of the further components and their treatment in the further processing machine. Also the type of further processing machine used and the thereby determined form of the further processing interacts with the hydrophilic polymer, and the further components. Thus a fiber matrix or a core can be obtained by means of a wetlaid-, wet-wipe- or airlaid device according to totally different processes. Thus, for example, the properties of the hydrophilic polymer act together with those of fluff such as fluff type (e.g. softwood or hardwood), fiber length, fluff moisture, fluff compression, etc., in the core production. In turn, the processing conditions of the fluff preparation have an influence on the fluff properties. The decisive properties of the core affected by the hydrophilic polymer in turn have an influence upon the properties of the diapers comprising this core and their production process. Typical determining properties influenced by the hydrophilic polymer are for example the rewet and leakage behavior or the further processing products.

In general, one aspect of the invention consists of contributing to overcoming the disadvantages arising from the prior art in the context of the production of hydrophilic polymers.

Another aspect consists of reducing the complexity of laboratory and pilot trials in the introduction of a new recipe for a particular specification profile in the production of hydrophilic polymers.

A further aspect of the invention consists in shortening the testing and initial breaking in phases for adjusting further processing machines such as core-, diaper-, fiber spinning-, and paper machines.

An additional aspect lies in adjusting specification profiles of hydrophilic polymers to a large degree directly in production, in order to be able to react more flexibly, more economically, and faster to client wishes. This can thus in turn produce more optimal hygiene articles, or other products based upon hydrophilic polymers.

A further aspect consists of achieving a substantially earlier recognition of production errors or disadvantageous properties of further processing products, in order to be able to intervene to correct or provide an automatic counter-control, as much as possible before the deficient product is formed.

An additional aspect of the invention consists in shortening lengthy and expensive test phases which arise upon changing the composition or the construction of further processing products produced on an industrial scale.

### DETAILED DESCRIPTION OF THE INVENTION

A contribution to the solution of these objects is made by a process for producing a hydrophilic polymer in a production device, whereby a computer-generated model, such as an artificial neuronal network, controls this production device.

The hydrophilic polymer may be a water-absorbent polymer based upon:
(α1) from about 0.1 to about 99.999 wt. %, such as from about 20 to about 98.99 wt. %, and such as from about 30 to about 98.95 wt. % of polymerized, ethylenically unsaturated, acidic groups-comprising monomers or salts thereof, or polymerized, ethylenically unsaturated monomers comprising a protonated or a quaternary nitrogen, or mixtures thereof, wherein mixtures comprising at least ethylenically unsaturated, acidic groups-comprising monomers, such as acrylic acid, may be utilized,
(α2) from 0 to about 70 wt. %, such as from about 1 to about 60 wt. % and such as from about 1 to about 40 wt. % of polymerized, ethylenically unsaturated monomers which can be co-polymerized with (α1),
(α3) from about 0.001 to about 10 wt. %, such as from about 0.01 to about 7 wt. %, and such as from about 0.05 to about 5 wt. % of one or more cross-linkers,
(α4) from 0 to about 30 wt. %, such as about 1 to about 20 wt. % and such as about 5 to about 10 wt. % of water-soluble polymers, as well as
(α5) from 0 to about 20 wt. %, such as from about 0.01 to about 7 wt. %, and such as from about 0.05 to about 5 wt. % of one or more additives,
   wherein the sum of the component weights (α1) to (α5) amounts to 100 wt. %.

The monoethylenically unsaturated, acid groups-comprising monomers (α1) can be partially or fully, such as partially neutralized. The monoethylenically unsaturated, acid groups-comprising monomers may be neutralized to at least about 25 mol %, such as to at least about 50 mol % and such as to about 50 to about 90 mol %. The neutralization of the monomers (α1) can occur before and also after the polymerization. Further, the neutralization can occur with alkali metal hydroxides, alkaline earth metal hydroxides, ammonia as well as carbonates, and bicarbonates. In addition, every further base is conceivable which forms a water-soluble salt with the acid. A mixed neutralization with different bases is also conceivable. Neutralization with ammonia, or with alkali metal hydroxides may occur, such as with sodium hydroxide, or with ammonia and, particularly, sodium hydroxide.

Further water-absorbent polymers products by the process according to the invention are polymers in which the free acid groups predominate, so that this polymer has a pH value lying in the acidic range. This acidic water-absorbing polymer may be at least partially neutralized by a polymer with free basic groups, such as amine groups, which polymer is basic compared to the acidic polymer. These polymers are termed “mixed-bed ion-exchange absorbent polymers” (MBIEA polymers) in the literature and are disclosed inter alia in WO 99/34843. As a rule, MBIEA polymers represent a composition that contain, on the one hand, basic polymers that are able to exchange anions, and on the other hand comprise a polymer that is acidic compared to the basic polymer, and that is able to exchange cations. The basic polymer has basic groups and is typically obtained by the polymerization of monomers that carry basic groups or groups that can be converted into basic groups. These monomers are, above all, those that have primary, secondary, or tertiary amines, or the corresponding phosphines, or at least two of the aforementioned functional groups. This group of monomers includes in particular ethyleneamine, allylamine, diallylamine, 4-aminobutene, alkyloxycyclene, vinylformamide, 5-aminopentene, carbodiimide, formaldacin, melanin, and the like, as well as their secondary or tertiary amine derivatives.

The disclosures of DE 102 23 060 A1, in particular with respect to the monomers (α1) and (α2) and the crosslinkers (α3) are hereby referenced.

Monoethylenically unsaturated, acid groups-containing monomers (α1) such as those cited in DE 102 23 060 A1 may be utilized as monomers (α1), such as acrylic acid.

According to the present invention, the water-absorbent polymer produced by the process according to the invention may comprise carboxylate groups-containing monomers to at least about 50 wt. %, such as at least about 70 wt. %, and such as at least about 90 wt. %, based on the dry weight. The water-absorbent polymer produced by the process according to the invention may be formed from at least about 50 wt. %, such as at least about 70 wt. % of acrylic acid, which may be neutralized to at least about 20 mol %, such as at least about 50 mol %.

As monoethylenically unsaturated monomers (α2) which are copolymerizable with (α1) may be utilized those monomers which are cited in DE 102 23 060 A1 as monomers (α2), whereby acrylamide may be utilized.

Cross-linkers (α3) according to the present invention may be compounds which have at least two ethylenically unsaturated groups in one molecule (cross-linker class I), compounds which have at least two functional groups which can react with functional groups of the monomers (α1) or (α2) in a condensation reaction (=condensation cross-linkers), in an addition reaction or a ring-opening reaction (cross-linker class II), compounds which have at least one ethylenically unsaturated group and at least one functional group which can react with functional groups of the monomers (α1) or (α2) in a condensation reaction, an addition reaction or a ring-opening reaction (cross-linker class III), or polyvalent metal cations (cross-linker class IV). Thus with the compounds of cross-linker class I, a cross-linking of the polymer is achieved by radical polymerization of the ethylenically unsaturated groups of the cross-linker molecules with the monoethylenically unsaturated monomers (α1) or (α2), while with the compounds of cross-linker class II, and the polyvalent metal cations of cross-linker class IV a cross-linking of the polymer is achieved respectively via condensation reaction of the functional groups (cross-linker class II), or via electrostatic interaction of the polyvalent metal cation (cross-linker class IV) with the functional groups of the monomer (α1), or (α2). With compounds of cross-linker class III, a cross-linking of the polymers is achieved correspondingly by radical polymerization of the ethylenically unsaturated groups as well as by condensation reaction between the functional groups of the cross-linkers, and the functional groups of the monomers (α1) or (α2).

Crosslinkers (α3) that may be utilized are all those compounds which are cited in DE 102 23 060 A1 as crosslinkers (α3) of the crosslinker classes I, II, III and IV, whereby
as compounds of crosslinker class I, N, N′-methylene bisacrylamide, polyethyleneglycol di(meth)acrylates, triallylmethylammonium chloride, tetraallylammonium chloride and allylnonaethyleneglycol acrylate produced with 9 mol ethylene oxide per mol acrylic acid may be used, and
as compounds of crosslinker class IV, Al₂ (SO₄)₃ and its hydrates may be used.

Water-absorbent polymers produced by the process according to the invention are polymers which may be crosslinked by crosslinkers of the following crosslinker classes or by crosslinkers of the following combinations of crosslinker classes respectively: I, II, III, IV, I II, I III, I IV, I II III, I II IV, I III IV, II III IV, II IV or III IV.

Water-absorbent polymers produced by the process according to the present invention may also be polymers, which are crosslinked by any of the crosslinkers disclosed in DE 102 23 060 A1 as crosslinkers of crosslinker classes I, whereby N, N′-methylene bisacrylamide, polyethyleneglycol di(meth)acrylates, triallylmethylammonium chloride, tetraallylammonium chloride, and allylnonaethyleneglycol acrylate produced from 9 mol ethylene oxide per mol acrylic acid may be used as crosslinkers of crosslinker class I.

The absorbent polymers may be produced from the above-named monomers and cross-linkers by various polymerization means. For example, in this context can be named bulk polymerization, which may occur in kneading reactors such as extruders or by belt polymerization, solution polymerization, spray polymerization, inverse emulsion polymerization, and inverse suspension polymerization. Solution polymerization may, according to the present invention, be carried out in water as solvent. The solution polymerization can occur continuously or discontinuously. From the prior art, a broad spectrum of variation possibilities can be learnt with respect to reaction proportions such as temperatures, type, and quantity of the initiators as well as of the reaction solution. Typical processes are described in the following patent specifications: U.S. Pat. No. 4,286,082, DE 27 06 135, U.S. Pat. No. 4,076,663, DE 35 03 458, DE 40 20 780, DE 42 44 548, DE 43 23 001, DE 43 33 056, DE 44 18 818.

As initiators for initiation of the polymerization, all initiators forming radicals under the polymerization conditions can be used, which are commonly used in the production of superabsorbers. Among these belong thermal catalysts, redox catalysts, and photo-initiators, whose activation occurs by energetic irradiation. The polymerization initiators may be dissolved or dispersed in a solution of monomers according to the present invention. Water-soluble catalysts may be used.

Thermal initiators that may be used in the present invention include all compounds known to the person skilled in the art that decompose under the effect of temperature to form radicals. Thermal polymerization initiators generally have a half life of less than about 10 seconds, such as less than about 5 seconds at less than about 180° C., such as less than about 140° C., may be used. Peroxides, hydroperoxides, hydrogen peroxide, persulfates, and azo compounds may be used as thermal polymerization initiators. In some cases it is exemplary to use mixtures of various thermal polymerization initiators. Among such mixtures, those consisting of hydrogen peroxide and sodium, or potassium peroxodisulfate may be used, and used in any desired quantitative ratio. Suitable organic peroxides are acetylacetone peroxide, methyl ethyl ketone peroxide, benzoyl peroxide, lauroyl peroxide, acetyl peroxide, capryl peroxide, isopropyl peroxidicarbonate, 2-ethylhexyle peroxidicarbonate, tert.-butyl hydroperoxide, cumene hydroperoxide, tert.-amyl perpivalate, tert.-butyl perpivalate, tert.-butyl perneohexonate, tert.-butyl isobutyrate, tert.-butyl per-2-ethylhexenoate, tert.-butyl perisononanoate, tert.-butyl permaleate, tert.-butyl perbenzoate, tert.-butyl-3,5,5-trimethylhexanoate, and amyl perneodecanoate. Furthermore, the following thermal polymerization initiators may be used: azo compounds such as azo-bis-isobutyronitrol, azo-bis-dimethylvaleronitril, 2,2-azobis-(2-amidinopropane)dihydrochloride, azo-bis-amidinopropane dihydrochloride, 2,2′-azobis-(N,N-dimethylene)isobutyramidine dihydrochloride, 2-(carbamoylazo)isobutyronitrile, and 4,4′-azobis-(4-cyano-valeric acid). The aforementioned compounds are used in conventional amounts, for example in a range from about 0.01 to about 5 mol %, such as about 0.1 to about 2 mol %, respectively based upon the amount of the monomers to be polymerized.

The redox catalysts contain as oxidic component at least one of the per compounds listed above, and contain as reducing component ascorbic acid, glucose, sorbose, mannose, ammonium, or alkali metal hydrogen sulfite, sulfate, thiosulfate, hyposulfite, or sulfide, metal salts such as iron II ions, or silver ions, or sodium hydroxymethyl sulfoxylate. Ascorbic acid or sodium pyrosulfite may be used as reducing component of the redox catalyst. About 1·10⁻⁵ to about 1 mol % of the reducing component of the redox catalyst and about 1·10⁻⁵ to about 5 mol % of the oxidizing component of the redox catalyst are used, in each case referred to the amount of monomers used in the polymerization. Instead of the oxidizing component of the redox catalyst, or as a complement thereto, one or more, water-soluble azo compounds may be used.

If the polymerization is initiated by action of energetic beams, so-called photo-initiators are generally used as an initiator. These can comprise for example so-called α-splitters, H-abstracting systems, or also azides. Examples of such initiators include benzophenone derivatives such as Michlers ketone, phenanthrene derivatives, fluorine derivatives, anthraquinone derivatives, thioxanthone derivatives, cumarin derivatives, benzoinether, and derivatives thereof, azo compounds such as the above-mentioned radical formers, substituted hexaarylbisimidazoles or acylphosphine oxides. Examples of azides include: 2-(N,N-dimethylamino)ethyl-4-azidocinnamate, 2-(N,N-dimethylamino)ethyl-4-azidonaphthylketone, 2-(N,N-dimethylamino)ethyl-4-azidobenzoate, 5-azido-1-naphthyl-2′-(N,N-dimethyl-amino)ethylsulfone, N-(4-sulfonylazidophenyl)maleinimide, N-acetyl-4-sulfonyl-azidoaniline, 4-sulfonylazidoaniline, 4-azidoaniline, 4-azidophenacyl bromide, p-azidobenzoic acid, 2,6-bis(p-azidobenzylidene)cyclohexanone, and 2,6-bis(p-azidobenzylidene)-4-methylcyclohexanone. The photo-initiators, when used, are generally employed in quantities from about 0.01 to about 5 wt. % based on the monomers to be polymerized.

A redox system comprising hydrogen peroxide, sodium peroxodisulfate, and ascorbic acid may be used according to the invention as “catalyst” or “redox initiator starter” As a rule, the polymerization is initiated with the initiators within in a temperature range from about 30° to about 90° C.

The polymerization reaction can be initiated by one initiator or by more than one initiator working together. The polymerization can furthermore be carried out in such a way that initially one or more redox initiators are added. In the further course of the polymerization, additional thermal initiators or photo-initiators are then applied, whereby in the case of photo-initiators the polymerization reaction is then initiated by the effect of energetic irradiation. The inversed order, i.e. the initial initiation of the reaction by means of energetic irradiation, and photo-initiators, and an initiation of the polymerization in the further course of the reaction by means of one or more redox initiators is conceivable.

In the context of the process according to the invention for producing a hydrophilic polymer, the water-absorbent polymer based upon the above cited monomers, may be continuous solution polymerization, in which a monomer solution comprising the above-cited monomers is continuously fed onto a polymerization belt, whereby the monomer solution polymerizes on the polymerization belt to form a polymer gel. The polymer gel is then continuously transformed into gel particles in a suitable gel comminution device and these gel particles may then be dried on a drying belt. A further milling and sieving of the dried gel particles then follows optionally as well as optionally a surface treatment, such as a surface post-crosslinking, of the thus-obtained gel particles.

In the surface treatment also described as post-crosslinking, the dried gel particle is converted with a post-crosslinker, which can be converted with the carboxyl groups of the polymer, such as an aqueous solution with a concentration within the range from about 0.001 to about 50, such as within the range from about 0.01 to about 20 wt. %, respectively based upon the post-crosslinker solution, with an amount within the range from about 0.0001 to about 20, such as within the range from about 0.001 to about 10 wt. %, respectively based upon the dried gel particle. As post-crosslinker are considered compounds of the crosslinker classes III and IV or mixtures thereof, whereby ethylene carbonate or aluminum sulfate may be used. In this context, reference is made to DE 40 20 780 C1. Among these, Al compounds and polyols, such as diols, or Al compounds and ethylene carbonate are considered. In this context, reference is made to DE 199 09 653 A1 and DE 199 09 838 A1.

The controlling of the production device may occur by determining at least one process parameter and via at least one process value based upon this at least one process parameter.

As process parameter are considered in principle all physically measurable status values which are connected with the production process. Among these status values are those which underlie variations during the process. Status values which form such process parameters are, for example, temperatures, pressures, flow rates, concentrations, moisture content, electrical flows, electrical resistances, turning, and conveying rates, or mechanical forces, and densities, whereby temperatures, concentrations, moisture content, throughput amounts, and mechanical forces may be used.

In contrast to the process parameters, which represent measured values, the process values are values which are actively adjusted within the scope of the control of the production device. This adjustment can be carried out indirectly or directly. An indirect process value can be, for example, a control signal which occurs in particular electronically. This control signal can, for example, effect a valve opening and thereby an increased addition of a given material. This increased material addition has in turn an effect upon a process parameter, in this case a given concentration of a given material, as a result. Another example of a process value is the increase, or decrease, of the performance of a thermal readier. The change in the performance has an effect upon the temperature as process parameter as a result. Process values are thus, for example, heating or cooling performance, added amounts, transport rates as in particular set for conveyor belts, or in transport screws or extruders, turning rates of comminution devices, in particular of mills.

Process parameters are therefore values, which are measured or can be measured. Process parameters are derived from the adjustments according to the process values.

The device which can be used for the process according to the invention comprises an educt area, a polymerization area attached thereto, and a first confectioning area likewise following therefrom. A post-crosslinking area can follow therefrom, which optionally comprises a further confectioning area. In the thus-formed production device, in the corresponding areas at least the following steps can be carried out following each other:
(a) an educt step,
(b) a polymerization step,
(c) a first confectioning step,
(d) optionally a post-crosslinking step, and
(e) optionally a further confectioning step.

These steps can be in turn split into further partial steps. In particular in the production of a lightly crosslinked, partially neutralized polyacrylate as hydrophilic polymer, based at least upon about 50 wt. % acrylic acid, initially a partial neutralization of the acrylic acid may occur by bringing into contact of the acrylic acid with sodium hydroxide. In this way, a degree of neutralization of the acrylic acid is set within the range from about 30 to about 80, such as about 50 to about 75 and such as about 60 to about 73 mol %. In this neutralization, the temperature may be determined as process parameter and in the case of exceeding this temperature to intervene to regulate by means of a suitable process value, either by variation of the addition, or by suitable cooling. To this end it is furthermore exemplary if the rate of flow of water, sodium hydroxide, and acrylic acid are determined as further process parameters. The process parameters of degree of neutralization, of acrylic acid, crosslinker, and co-monomer concentration can be determined on the one hand by back-calculating the amounts used via their ratios. On the other hand, the possibility exists to determine analytically, and thus absolutely the ratio of the various mentioned components. A further partial step of the product preparation step sets the best suitable temperature for the polymerization in a cooling step. The temperatures of the monomer, co-monomer, and crosslinker mixtures here represent a process parameter. The respective cooling or heating performance, which respectively act upon this mixture represent in turn a process value. The educt mixture may have a temperature from about 1 to about 20, such as from about 2 to about 15 and such as from about 3 to about 7° C., before it is conducted to the polymerization. A further partial step of the product performance step, which can be either before or after, such as after the cooling, is a step in which the oxygen content of the educt mixture is reduced. This step which is also described as “stripping” can additionally serve the object of foaming the educt mixture, for example directly before the polymerization, so that the hydrophilic polymer arising in the polymerization has a porosity or a foam-like structure, as described inter alia in EP 0 827 753 A1, and in which has a volume ratio from about 1.01 to about 5, based upon the educt volume before the gassing is exemplary. It can here be exemplary to mix the educt mixture with a surface active substance. It can thus be necessary that in the context of the stripping the content of oxygen, or displacing protective gas, such as nitrogen, the density of the educt mixture as well as the concentration of a surface-active agent are determined as process parameters, whereby the measurement of the oxygen, or protective gas concentration is particularly important. In connection with the stripping, the added quantities, or flow rate of protective gas and, in the case of formation of a foam, the amount of surface active agent, in particular, form important process values.

The polymerization step can also be split into different partial steps, which can be dependent individually upon the polymerization device employed. Stationary and continuously working polymerization devices are here considered, whereby the continuously working devices are exemplary. An important group of process parameters for a continuously working polymerization device are the flow rate of educt mixture, and for the case that besides the initiator a further catalyst is used, as is the case in particular for redox initiated polymerizations, the flow rate of the catalysts. A further process parameter linked with these process parameters is the dwell time educt mixture polymerizing through bit by bit in the polymerization device. As process value are considered in this case conveyor rates of the transport means. These transport means are mostly either polymerization belts, or screws, or conveyor stirrer. In the case of the polymerization belt, the belt rate represents a process value. In the case of the screw or conveyor stirrer, the rotation rate of this screw or conveyor stirrer and, in the case that the screw or conveyor stirrer paddle can be varied in its blade angle, these likewise represent a process value.

Furthermore, the entry of a polymerization additive can also be exemplary. In this context, for example, the entry of further blowing agents such as carbonates, for example sodium carbonate, should be cited, whereby may occur as an aqueous solution with for example blowing agent within the range from about 0.5 to about 50, such as within the range from about 1 to about 25 wt. %, respectively based upon the blowing agent solution. In this way the amount of blowing agent solution to be determined by valve settings represents a process value which is influenced by various process parameters, such as density of the polymerization solution, density or porosity of the hydrophilic polymer and others.

The first confectioning step provided in the first confectioning area can be likewise split into different partial steps, whereby these include, for example, a comminution, drying, and milling steps. As process parameter in the comminution step are considered, in particular, the discharge length per time of polymer from the polymerization conveyor device, as well as the consistency of the polymer. The consistency of the polymer can be established on the one hand by suitable mechanical tests, for example by compressive stress, or tensile stretching test directly, or indirectly via the electricity consumption of the corresponding comminution means. Another process parameter of the comminution step can be represented by the compressibility of the polymer leaving the comminution step. Because the polymerization in the polymerization device mostly occurs as solvent polymerization in aqueous solvent, the hydrophilic polymer is obtained after the polymerization step as water- comprising hydrogel. The water content, the degree of comminution and also the temperature of the polymer present as a hydrogel can have an influence upon the compressibility. Exemplary process values set in the comminution step are the rates of the comminution devices such as kneaders as well as a subsequent grinder (“Wolf”) and, if a homogenization of the comminuted hydrogel is intended, the rate of the homogenization drum. Furthermore, the temperature of the hydrogel at the end of the comminution step can be significant. This is particularly the case, if a post-initiation is intended, which can be exemplary for reducing the residual monomer content of the hydrogel.

The drying follows the comminution. This can be divided into different drying cells. Process parameters of the drying are exemplary on the one hand and include the water content, and the temperature of the hydrogel entering the drying. This can be determined on the one hand for the drying in total and additionally also for the individual cells in the drying. A further process parameter is represented by the temperature in the drying and, if more cells are present, in at least some, such as each of the cells. As exemplary process value of the drying area, the transport speed and the heating performance associated with the temperatures in the drying, or respectively in the cells of the drying should be mentioned. For the case that a circulating air dryer is used, the amount of air made available to the drying per time may be used as process value, in addition to the heating performance.

Milling as further partial step of the first confectioning step follows the drying. An exemplary process parameter in the case of the milling is the consistency of the now substantially water-free hydrophilic polymer. This can be determined directly via mechanical load experiments such as shear experiments, or penetration experiments. An indirect determination of the consistency can, however, also occur via the electricity consumption of the mill equipment. Besides the temperature of the hydrophilic polymers passing from the drying into the milling, their residual water content can also be determined as process parameter for the milling. As process values besides the rate of the mill equipment used in the milling, the setting has to be considered, in particular the mill gap set between two mill tools. Furthermore, the movement frequency (mostly vibration) of a “hopper” responsible for as uniform an admission to the mills as possible can also be exemplary for a good mill result. The frequency of this hopper representing a process value lies within the range from about 1 to about 100 Hz. For the case that in the milling more than one mill steps are arranged one after the other, the above process parameters and process values are valid respectively for each individual of these mill steps which follow each other. In this case, in particular the feed amount of hydrophilic polymers to be milled forms a process value.

The hydrophilic polymer powder contained in the first confectioning step can optionally be subjected to a post-crosslinking step, which in turn splits into a number of partial steps following each other. The hydrophilic polymer powder is often initially intermediately stored in a pre-product silo. In this case, the temperature and moisture of the hydrophilic polymer powder are determined as process parameter. Further process parameters of the post-crosslinking step are formed by the flow rate of hydrophilic polymer powder and of post-crosslinkers used for the post-crosslinking reaction. The process values which may be used in connection with the post-crosslinking step relate to the regulation of the doser for hydrophilic polymer powder, one or more post-crosslinkers as well as the rotation speed of the mixture. A further significant process parameter of the post-crosslinking step is the temperature of the mixer. In the case that the mixture has various differently controlled mix sections, at least two, for example all temperatures of these mix sections may be used as process parameter. The process value associated with the temperature is the heating performance of the mixer or of respectively the individual sections of mixer. This heating performance can, for example, be provided by more or less strong steam entry into the mixer which is temperature-controlled by steam or respectively into the mix sections which are temperature-controlled by steam. A further process parameter is the temperature of the hydrophilic polymer after passing through the mixer.

A further process parameter after passing through the mixer can be the wetness of the hydrophilic polymer.

In the optionally provided further confectioning step, the above-obtained hydrophilic polymer can be transformed with further substances. These can act against dust formation, as is the case for polyethylene glycol as dust reducer. Other typical additives or confectioning agents are, for setting the absorption properties, water, for coloring or odor binding, active charcoal, carbohydrates such as starches, lignin, Si-compounds, in particular Si oxides, and green tea extract.

It is furthermore optional that on the basis of the process parameters collected as described above, the at least one process value is calculated by means of the computer-generated model, such as the artificial neuronal network. In this context this calculation may be based upon at least two, such as at least five, such as at least eight and such as at least ten process parameters. It is further optional that not only one process value, but rather at least two, such as at least four and such as at least ten process values are calculated in this way.

Besides the artificial neuronal network, or in connection with it, a model described in the literature as “Fuzzy Logic” can be used according to the invention. Reference is here made to an elaboration of a seminar presentation of Babara and Olav Seyfarth on Cooperative and Hybrid neuro-fuzzy systems at the chair of professor Dr. Karl Heinz Meisel of 19 Jun. 2000 published under http://privat.seyfarth.de/olav/neuro-fuzzy-systeme.html and the article Erfolgreiche Anwendung von Fuzzylogic und Fuzzy controle (Teil 2), Automatisierungstechnik 50, 511 ff (2002), from Bern-Markus Pfeiffer et al. and 9. Neuronale Fuzzy Systeme under http://www.iicm.edu/greif/node11.html from Gerhard Reif.

According to a further embodiment of the process of the present invention this process, in particular the polymerization step such as the polymerization step and the first confectioning step run continuously. By continuously is understood according to the invention that the production process is not carried out portion or charge-wise, but consecutively. It is thus optional that the process according to the invention is divided into at least two process steps. In each of these at least two process steps, respectively at least one step parameter is determined as process parameter.

It is additionally optional that the at least one step parameter influences at least one process value. In this connection it is optional that this process value lies in another process step to that in which the step parameter was determined. It is further optional that the at least one step parameter influences at least two process values, whereby at least one of these two process values lies in one process step which lies outside the process step in which the step parameter was determined.

Furthermore, in the process according to the invention, the control may occur by means of a store of experience associated with at least one experience parameter. The experience parameter is at least one, such as at least two, and such as at least three physical or chemical properties of a hydrophilic polymer. The experience parameters in the process according to the invention may be characterized by at least one such as each of the following properties:
P1 The retention of an aqueous liquid (CRC),
P2 the absorption of an aqueous liquid,
P3 the absorption of an aqueous liquid against pressure,
P4 the absorption rate of an aqueous liquid,
P5 the absorption rate of an aqueous liquid against pressure,
P6 the particle size distribution,
P7 the residual monomer content,
P8 the saline flow capacity (SFC) according to EP0 752 892 B1,
P9 the bulk density,
P10 the pH value,
P11 the flowability or
P12 the color (according to the Hunter-Color Test).

The experience parameters, in particular the above, can be determined by means of processes generally common for the skilled person. In particular are determinations by so-called ERT methods (EDANA Recommended Tests—EDANA: European Diaper And Nonwoven Association).

In principle, each of the above-cited properties represents individually or in combination an embodiment of a possible experience parameter. Exemplary embodiments of property combinations as experience parameters are represented by the following combinations represented as combinations of letters: P1P2P3P4P5P6P7, P1P2, P1P3, such as P1P3P4P5P6P7P8P9 and such as P1P3P4P5.

The store of experience is formed by a learning process in which, over a given time period, process parameters, process values, and the experience parameters resulting from the production upon application of these process parameters, and process values of the respectively obtained hydrophilic polymer are determined. By means of an array of such determinations, a collection of data is created, upon basis of which the computer-generated model or respectively the neuronal network is formed by training. Should, after successful ending of the learn step, a given hydrophilic polymer with certain physical or chemical properties be prepared, these physical or chemical properties are given as should-be experience parameters. Via the artificial neuronal network, initially the thereto-belonging should-be process parameters, and should-be process values are determined. With these, the production of this given hydrophilic polymer is started. By determination of the actual process parameter, by means of the artificial neuronal network the should-be process values given at the start can optionally be modified and the real actual process values are approached to these should-be process values. A further possibility for correcting the should-be process values is offered by the determination of the actual process parameters of the hydrophilic polymer obtained at the start of the production process and their comparison with the should-be process parameters by means of the artificial neuronal network. This comparison also has effects upon the process values in general and the should-be process values in particular. By the above-described iterative process, by using the artificial neuronal network the production device can be controlled in such a way that the given should-be experience parameters can be achieved after a comparably short time.

In the process according to the invention the store of experience may be manifested by the computer-generated model, such as the artificial neuronal network. This manifestation can, for example, occur in that in a suitable computer circuits typical for neuronal networks form. Also, the store of information may be obtainable by a learn process.

In this way, on the one hand starting from at least one, such as at least two and such as at least seven experience parameters, process parameters and process values, such as process values for the operation, such as for the start-up of a production device for hydrophilic polymers can be predicted. Furthermore, starting from at least one, such as at least two and such as at least ten process parameters or from at least one, such as at least two and such as at least ten process values, or both, experience parameters and thus physical or chemical properties of a hydrophilic polymer for a given device for producing hydrophilic polymers can be predicted.

In another aspect of the invention, the process according to the invention comprises an artificial neuronal network with at least one first artificial neuron and at least one, such as at least two and such as at least four further artificial neurones following the first artificial neurone. A neurone is in particular connected with other neurones via connections I=1, . . . N. Via these connections, or also from the environment, entry signals xᵢ can arrive in the neurone. A neurone comprises in particular weights wᵢ for each connection between this neurone and other neurones and at least one activation function which determines the output signal of the neurone in dependence upon, for example, an input signal weighted with the weights of the input signals. A neuronal network which comprises at least two neurones, whereby each neurone is connected with at least one other neurone, can learn from experience, for example from a store of experience, and thus, for example, be “trained”.

This learn process can be reflected, for example in a change of at least one of the weights wi of at least one neurone. Further details can be found from 8. neuronal nets under http://www.iicm.edu/greif/node10.html.

In an additional aspect of the invention, in the first artificial neurone an input occurs by means of an input signal. This input signal may be indirectly or directly a process parameter. In a further aspect, from the further artificial neurone an output occurs by means of an output signal. This may be an electric signal which acts indirectly or directly as process value or upon a process value. Thus, the at least one process parameter may correlate with at least one input signal of the first artificial neurone. In a further aspect according to the invention, the at least one process value correlates with at least one output signal of the at least one further artificial neurone.

The experience parameters often correlate with the weights or weight sums of the activation functions which form in the computer-generated model. A further contribution to the solution of the object according to the invention is offered by a prediction process for pre-determining at least one, optionally each of the following values:
G1: a G-process parameter,
G2: a G-process value,
G3: a G-experience parameter,

In connection with a hydrophilic polymer or production thereof or both, comprising the following steps:
V1: operation of a production of a hydrophilic polymer, thereby
V2: determining at least one of the V-values
i) of a V-process parameter,
ii) a V process value,
iii) a V experience parameter,
V3: processing of the at least one V-value in a data processing unit to form a store of experience in the form of a computer-generated model, such as an artificial neuronal network,
V4: providing at least one G value based upon this store of experience.

The production of a hydrophilic polymer may be carried out in the production device for which a predetermination of a G value should occur. This serves in particular the purpose that with as little as possible or no pre-experiments in an existing production device, such as a production installation, as reliable as possible a prediction can be obtained. In the determination of different V-values the production in the production device may occur under different conditions. In this way, an amount of data can be obtained which allows the generation of an artificial neuronal network which leads to reliable predictions even in the case of large variations.

In step V2, it is exemplary to determine the different values in so-called data sets. It is here exemplary that the values for a given hydrophilic polymer are recorded as released chronologically over the course of the production. Thus the data set for a given hydrophilic polymer has the values from the educt preparation step, and the values recorded somewhat later likewise for this hydrophilic polymer from the polymerization step and the values corresponding to exactly this hydrophilic polymer in turn somewhat later upon passing through the first confectioning step, and the following steps. In this way a data set can be defined as the sum of all values of a given product along the production process. It is exemplary to collect at least about 100, such as at least about 250 and such as within the range from about 300 to about 600 data sets in step V2, whereby the quality of the computer-generated model generally improves with the amount of data sets. Furthermore, the computer-generated model can be improved by a weighted selection of data sets—generally described in the literature as “typicals”.

On the basis of the determined Values, a computer-generated model, such as a neuronal network, forms in a suitable computer by formation of suitable links. This process can also always be further repeated during the production of hydrophilic polymer, which leads to a constant further development of the computer-generation model or respectively of the artificial neuronal network. In general, the prediction capability of the computer-generated model or respectively of the artificial neuronal network increases with the length or repetition of the learning steps V1 to V3, whereby the increase decreases from repetition to repetition. The provision of the G values based upon the thus-obtained store of experience, may occur in that one of the G values is given and the other G values are determined using the artificial neuronal network.

It can thus, for example, occur, that a given specification profile of a hydrophilic polymer is given by particular G experience parameters, and then G process values, and G process parameters are determined. In another variety, the one prediction is sought for the case in which a G process value is varied. The artificial neuronal network then delivers a prediction concerning which effects the change of the G process value has upon the G process parameter, and in particular upon the G experience parameter, and thus the property profile of the hydrophilic polymer. It is further possible to predict the effects of the variation of a G process parameter upon G process values, or G experience parameters, or both by the artificial neuronal network for a given production device. It is thus exemplary in the production process according to the invention that at least one G value contributes to controlling the production device. This contribution can in particular lie in three-setting correspondingly process values for the start phase at the start of a production of a hydrophilic polymer in the different areas of the production device, and thus the start-up phase until a stable state is reached can be significantly shortened.

The invention further relates to composites, hygiene articles, fibers, sheets, foams, formed bodies, soil improvers, flocculation additives, paper additives, textile additives, water treatment additives, or leather additives, such as hygiene articles, in particular baby diapers, sanitary napkins, tampons, and incontinence articles, for example baby diapers, comprising a hydrophilic polymer obtainable by a production process according to the invention.

In addition, the invention relates to the use of a hydrophilic polymer obtainable by a production process according to the invention, in composites, hygiene articles, fibers, sheets, foams, formed bodies, soil improvers, flocculation additives, paper additives, textile additives, water treatment additives, or leather additives, such as hygiene articles, in particular baby diapers, sanitary napkins, tampons, and incontinence articles, for example baby diapers.

As a further aspect of the invention, a process for producing a further processing product comprising a hydrophilic polymer, in a further processing machine is proposed, comprising as process steps:
providing
   the hydrophilic polymer, and
   at least one further processing component
   bringing into contact the hydrophilic polymer and the at least one further processing component to obtain the further processing product,
wherein a computer-generated model, such as an artificial neuronal network, controls the further processing machine.

In particular, the polymer is obtained according to the process according to the invention. The further processing product can in particular be absorbent composites, diapers, paper, hygiene articles, sanitary napkins, incontinence articles and the like. With papers, in particular water or aqueous liquid-absorbent papers such as wiping-, kitchen or toilet papers are examples. Here, by further processing components are understood for example fibers such as in particular cellulose fibers, polymers, adhesives, water, solvents and others, which are different from the hydrophilic polymer.

Particularly exemplary here is a formation, in which the hydrophilic polymer is produced controlled by a first neuronal network and the further processing machine is controlled by a second neuronal network, whereby first and second neuronal network can be crosslinked with each other at one or more points in a particularly exemplary way. In particular, first and second neuronal network can also be connected to a common neuronal network.

The further processing of polymers, in particular of hydrophilic polymers, with further processing components to a further processing product comprising a hydrophilic polymer in a further processing machine, represents a complex task for a regulation process, since a plurality of process parameters and a plurality of process values are present. In a further processing process, these are described as W process parameters and W process values, in order to be able to distinguish them from the above-introduced process values and process parameters. The W process parameters and/or the W process values are interchangeably coupled, in particular a complex and/or non-linear coupling of a plurality of values is present, which leads to an almost chaotic behaviour. That means that a small change in a W process value and/or a W process parameter leads to a large change in one or more properties of the further processing product. The same can also be the case for a change in one process value and/or one process parameter in the production of the hydrophilic polymer. By corresponding design of the neuronal net, as well as the individual neurons and the connection of these functions, in particular the design of the corresponding weight of each neurone and of the activation function, a control can be realized, which, for example, makes more difficult or even prevents sliding into an almost chaotic state as described above by corresponding learning, for example by corresponding changing of the weight of the connections of the neuronal network. Thus the control or the neuronal net can react correspondingly for future changes of at least one process value, W process value, one process parameter and/or W process parameter, in order to obtain the desired properties of the polymer and/or of the further processing products nonetheless. Particularly, neurones can be conceived which can process not only discrete values as input signals. In particular, the computer-generated model is based alternatively or cumulatively upon the principle of “Fuzzy Logic”.

According to an embodiment of the process according to the invention, the computer-generated model of the production device and the computer-generated model of the further processing machine interact with each other.

Thus the influences of at least one process parameter and/or at least one process value upon the properties of the further production product in respectively the control or the regulation of the further processing machine can be taken into account. In particular, both computer-generated models can communicate with each other via defined interfaces, via which in particular at least one process parameter, in particular at least one process parameter, at least one process value, at least one W process parameter and/or at least one W process value can be exchanged and/or adjusted. In particular, the two computer-generated models can also be crosslinked with each other. If the computer-generated models are formed as neuronal networks, it is in particular possible that both computer-generated models comprise one or more neurons in common.

According to a further embodiment of the process according to the invention the control occurs by determining at least one W process parameter and via at least one W process value based upon this at least one W process parameter. This is particularly the case also for a corresponding regulation process.

The control or regulation can occur alternatively, or additionally also by determination of at least one process parameter and via at least one process value based upon this at least one process parameter. The determination of the at least one W process parameter and/or of the process parameter can occur directly, by means of a corresponding measuring element, for example a temperature, pressure, moisture, density, concentration, and/or pH sensor, or indirectly via determination of another measured value and subsequent fit or back-fit respectively to the desired process parameters and/or W process parameters.

According to a further embodiment of the process according to the invention, the computer-generated model, such as the artificial neuronal network, calculates the at least one W process value.

In one aspect of the invention, the computer-generated model calculates the W process value based upon at least one process parameter and/or at least one W process parameter. More than one W process value may be calculated from at least one process parameter and/or at least one W process parameter. A process parameter and/or a W process parameter can thus influence one or more process values and/or W process values.

According to a further embodiment of the process according to the invention, this process occurs continuously.

In particular, the continuous calculation of process values and/or W process values, as well as the continuous surveillance of at least one physical and/or chemical property of the further processing product allows a control and/or regulation which, for example, effectively hinders larger, in particular spring-like, changes in the properties of further production product and which allows for example a very precise setting and surveillance of properties of the further processing product and thus enables a production with only small tolerance bands of this property. In particular, by a continuous process is also understood a process in which the further processing product is not produced charge-wise and/or in which the output of further processing product per time unit is substantially constant.

According to a further embodiment of the process according to the invention, in each of the at least two process steps respectively at least one W step parameter is determined as W process parameter. For example type of fluff, fluff moisture, and/or mill type (for fluff defibration) represent these.

Additionally, the at least one W step parameter influences at least one W process value. Thus, this W process value may lie in another process step to that in which the W step parameter was determined. For example, the at least one W step parameter may influence at least two W process values, whereby at least one of these two W process values lies in one process step, which lies outside the process step in which the W step parameter was determined. Through these measures, the parameters and values of two or more process steps can be correlated and compared with each other, which can in turn have influence upon the control or regulation respectively of the whole further processing machine. W process values are, for example, fluff or fiber feed, variable defibration gap, conveyor rate, sieve size (of the sieve in a hammer mill), hammer type (material, hardness or design), air speed, or respectively air volume flow and/or air flow.

According to a further embodiment of the process according to the invention, the control occurs by means of a W store of experience associated with at least one W experience parameter. Analogously a corresponding regulation can also occur.

The W experience parameter is at least one, such as at least two, and for example at least three physical and/or chemical properties of a further processing product, such as a diaper.

In one aspect, the W experience parameter in the process according to the invention is characterized by at least one, such as all of the following properties:
W1: Rewet,
W2: leakage,
W3: wicking,
W4: absorption rate,
W5: spreading of the liquid (“spreading” in spread direction and surface),
W6: integrity in dry or wet state.

Properties W1 to W6 represent respectively by themselves or in each conceivable combination a W experience parameter. The following combinations stand respectively for an embodiment of a W experience parameter: W1W2W3W4W5; W2W3W4W5W6; W1W3W4W5W6; W1W2W4W5W6; W1W2W3W5W6; W1W2W3W4W6; W1W2; W1W3; W1W4; W1W5; W2W3; W1W4; W1W5; W1W6; W3W4; W3W5; W3W6; W3W4W5; W4W5W6; W1W5W6 or W1W3W5.

These parameters are determined according to methods known in the literature. The skilled person selects which of the literature methods to apply depending upon the further processing product. Thus for example methods with blood-containing body fluids are different to methods for urine. An overview of different test processes is provided by the outcall Are expensive diapers always the best? by Walter Becker based upon a presentation at the Insight 96 Absorbent Products Conference and the contribution of Dr. Edgar Herrmann at the EDANA 1997 NORDIC NONWOVENS SYMPOSIUM with the title Premanufactured Airlaid Composites Containing Superabsorbents. Furthermore, W values can be determined by suitable laboratories such as Ekotec GmbH in Ratingen, Germany. For example, here, in particular for the core and diaper area, for the individual W values the following methods are detailed: rewet U.S. Pat. No. 6,359,192, leakage U.S. Pat. No. 6,580,014, Wicking U.S. Pat. No. 6,359,192, absorption rate U.S. Pat. No. 5,147,345 and U.S. Pat. No. 6,085,579, spreading of the liquid (“spreading” in spread direction and area) manual for Ekotester, Ekotec GmbH Ratingen, 1991 as well as integrity in dry or wet state U.S. Pat. No. 5,833,678.

According to a further embodiment of the process according to the invention, the W store of experience is manifested by the computer-generated model, such as by the artificial neuronal network.

It is in particular in this context that the W store of experience and/or the store of experience manifests itself in the connection weights of the individual connections of the neuronal network. In particular, an adjustment of the W store of experience occurs by a change in the corresponding connection weights.

According to a further embodiment of the process according to the invention, the W store of experience is obtainable by means of a learning process. This can be formed with the learning process for the store of experience in connection with the hydrophilic polymer.

Through the surveillance of at least one physical and/or chemical property of the polymer, and/or of the further processing product, and of a correlation analysis of this at least one property with the process parameters, process values, W process parameters and/or W process values, the influence of these values upon the at least one property can be analyzed, and the W store of experience and/or the store of experience correspondingly adapted.

According to a further embodiment of the process according to the invention, the artificial neuronal network comprises at least one first artificial neurone and at least one further artificial neurone following the first artificial neurone. Further details are found from 8. Neuronale Netze under http://www.iicm.edu/greif/node10.html.

In another aspect of the process according to the invention that in the first artificial neurone an input occurs by means of an input signal. This input signal may be indirectly or directly a process parameter.

In an additional aspect of the process according to the invention from the further artificial neurone an output occurs by means of an output signal. This may be an electric signal, which acts indirectly or directly as process value or upon a process value. The at least one process parameter may correlate with at least one input signal of the first artificial neurone. Also, the at least one process value may correlate with at least one output signal of the at least one further artificial neurone.

The experience parameters often correlate with the weights or weight sums of the activation functions which form in the computer-generated model.

According to a further embodiment of the process according to the invention, the further processing machine is a fiber spin machine, fiber matrix machine, paper machine, core machine, wound dressing machine, or diaper machine.

Further processing products are generated from a hydrophilic polymer and at least one further processing a component, such as from two or more further processing components. The properties of these further processing products are in particular dependent upon the physical and/or chemical properties of the polymer, wherein in particular only a small change in the properties of the polymer can effect a comparably large change in the properties of the further processing product. In particular, in such cases, the control or regulation respectively in particular by means of at least one neuronal network is exemplary.

According to a further embodiment of the process according to the invention, the further processing product is fibers, fiber matrices, paper, cores, wound dressings, or diapers.

According to a further aspect of the inventive concept, a prediction process is proposed for pre-determination of at least one of the following WG values:
WG1: a W process parameter or process parameter,
WG2: a W process value or process value,
WG3: a W experience parameter or experience parameter,
   in connection with a hydrophilic polymer and/or a further processing product or its production or both. The process comprises in particular the following steps:
V1: operation of a production of a further processing product, thereby
V2: determination of at least one of the WV values
i. a WV process parameter,
ii. a WV process value,
iii. a WV experience parameter,
V3: processing of the at least one WV value in a data processing unit to form a store of experience in the form of a computer-generated model, such as of an artificial neuronal network,
V4: making available of at least one WG value based upon this store of experience.

By means of the prediction process according to the invention, in particular W process parameters, process parameters, W process values, process values, and W experience values, and experience values can be predicted. The W experience values comprise in particular physical and/or chemical properties of the further processing product. These comprise in particular the above-described parameters W experience parameter. Thus in particular by means of predetermined properties of the further processing product, W process parameters, process parameters, W process values and/or process values can be predicted. This leads to a reduced burden of experimentation and allows a significantly faster introduction of a further processing product generation.

According to a further aspect of the present invention, a prediction process for predetermining at least one of the following WG values
WG1: a W process parameter or process parameter,
WG2: a W process value or process value,
WG3: a W experience parameter or experience parameter,
   in connection with a hydrophilic polymer and/or a further processing product or its production or both is proposed, wherein at least one WG value based upon an available store of experience is made available.

The available store of experience is in particular based upon experiences of the computer-generated model, in particular of the neuronal network, which are obtained before the making available of the WG value. These available experiences can also be obtained by the above-described prediction process or one of the here described production processes.

The invention is now described by means of non-limiting examples.

In the following are given by way of clarification:

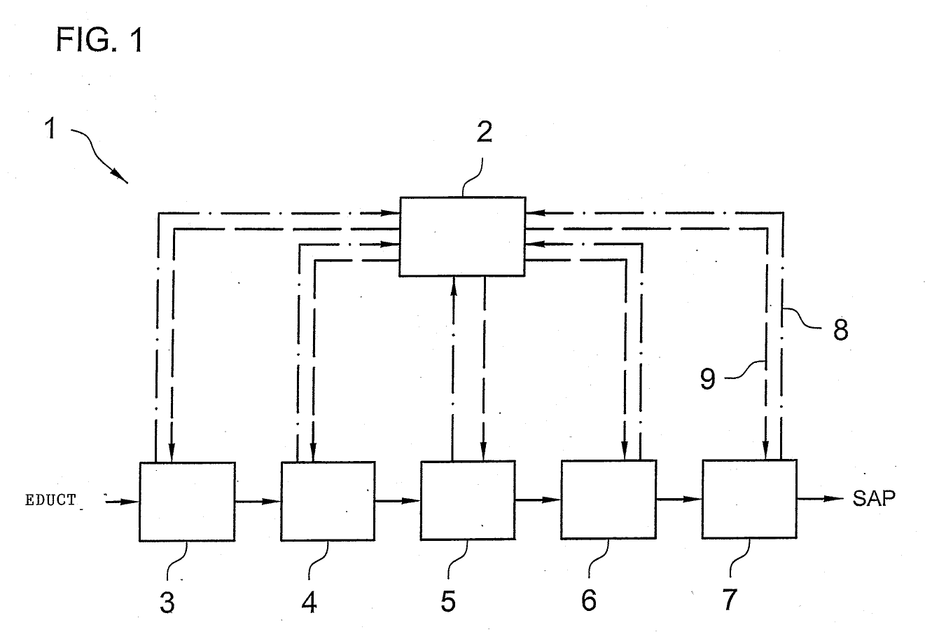

FIG. 1 is a schematic representation of a production device according to the invention;

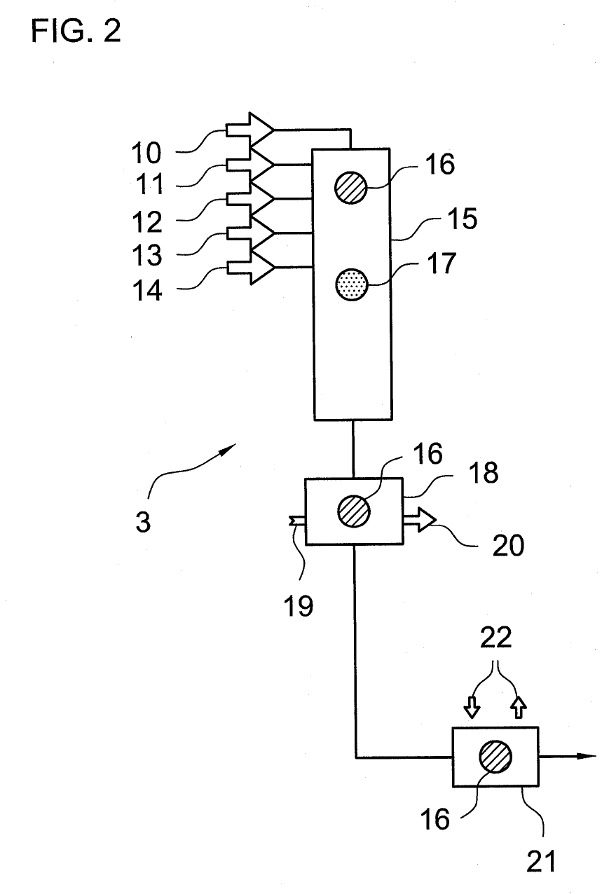

FIG. 2 is a schematic representation of an educt area;

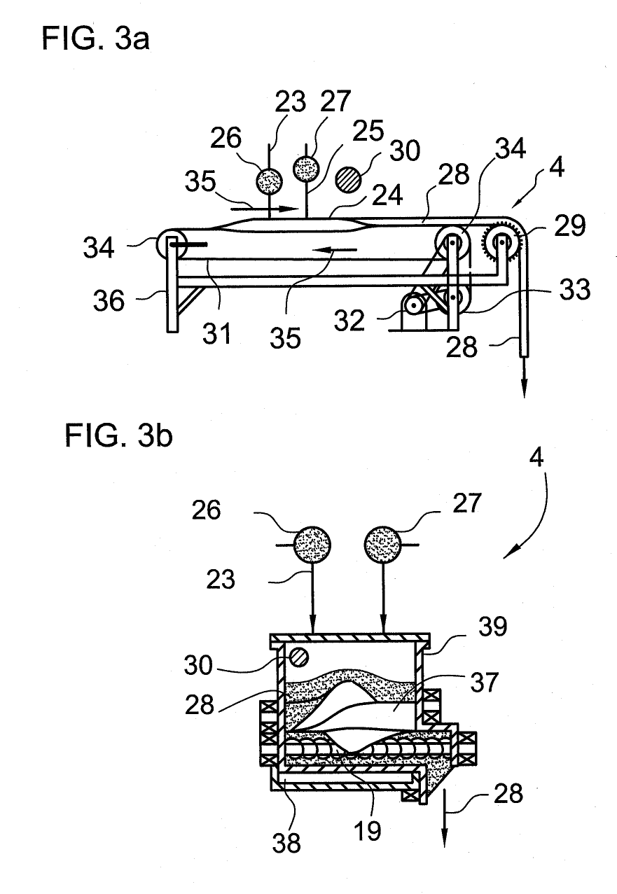

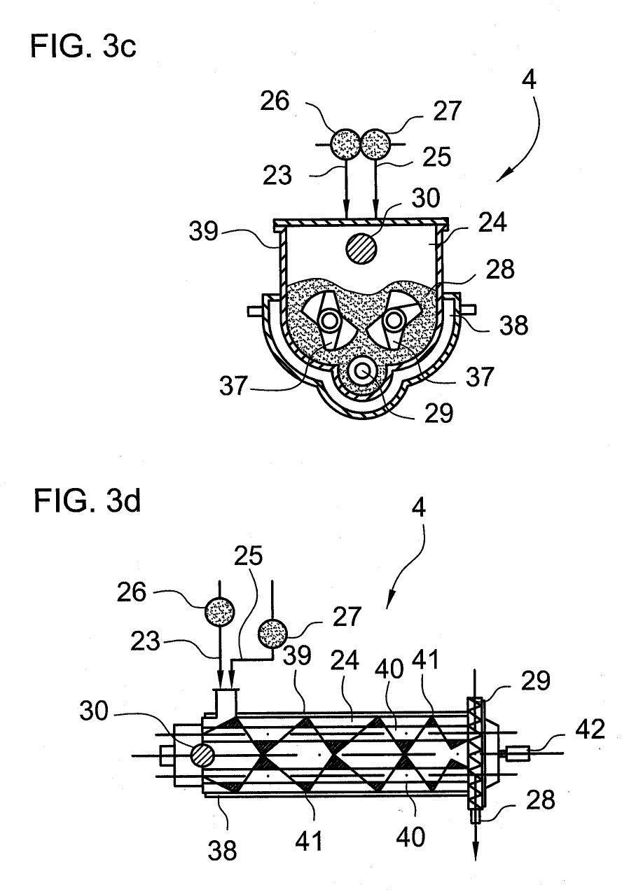

FIGS. 3A to 3D are schematic representations of polymerization areas;

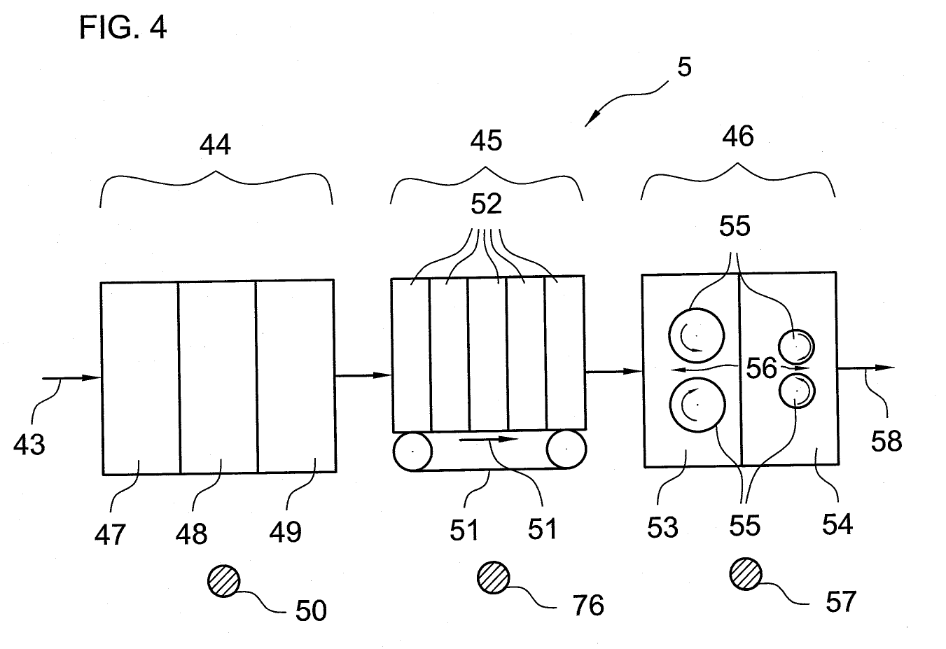

FIG. 4 is a schematic representation of a first confectioning area;

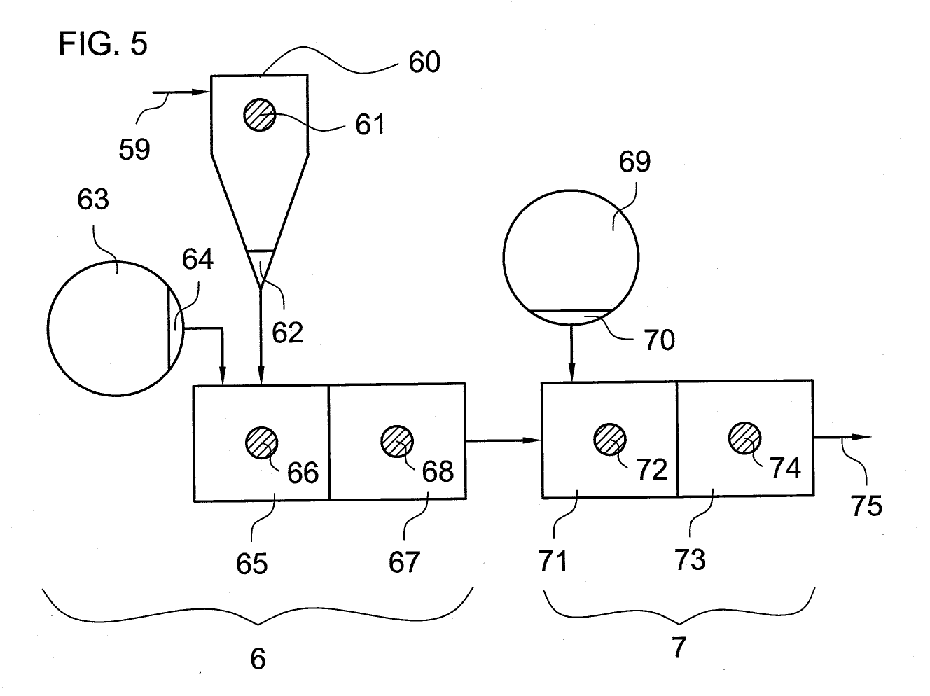

FIG. 5 is a schematic representation of a post-crosslinking area and of a further confectioning area;

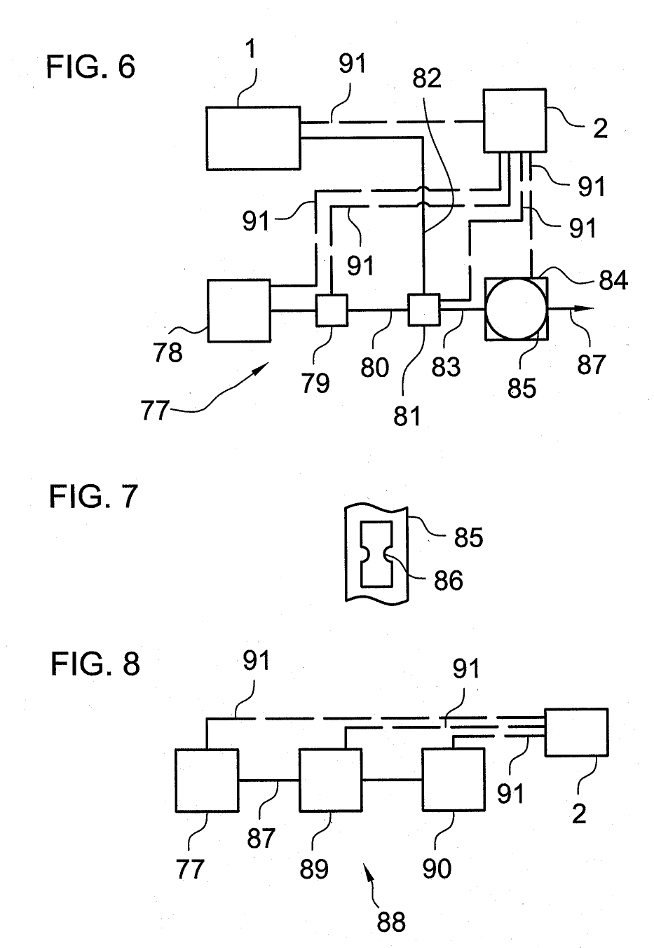

FIG. 6 is a schematic representation of a further processing machine controlled according to the process according to the invention;

FIG. 7 is a detailed schematic representation of the further processing machine according to FIG. 6;

FIG. 8 is a schematic representation of an embodiment example of a diaper producing machine controlled according to the process according to the invention;

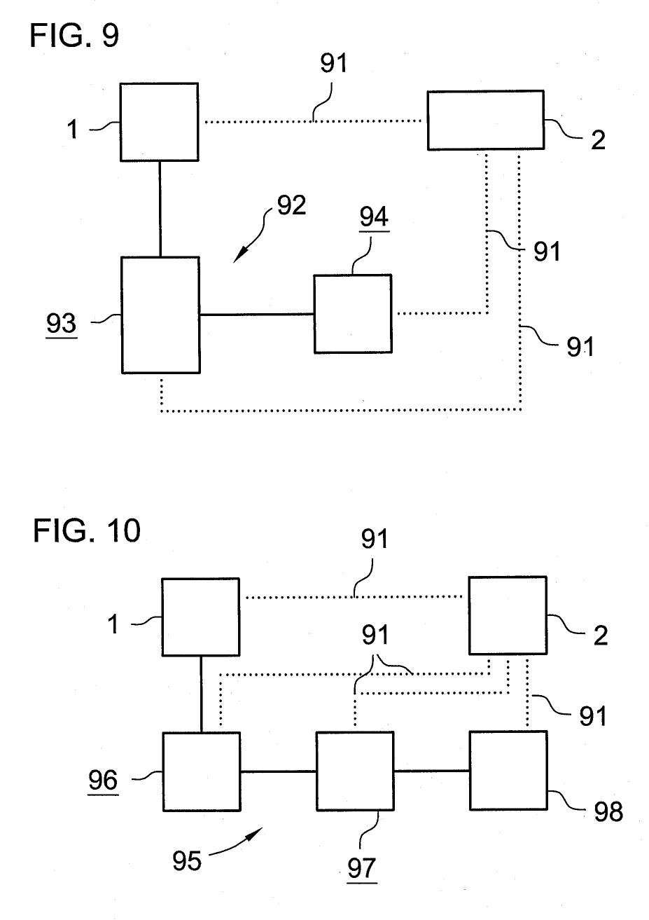

FIG. 9 is a schematic representation of an embodiment example of a paper production machine controlled according to the process according to the invention; and

FIG. 10 is a schematic representation of an embodiment example of a fiber production device controlled according to the process according to the invention.

In FIG. 1, a production device 1 comprises a computer 2, which may be located in a process control center of the production device. This computer 2 is connected with the different areas of the production device 1, such as with an educt area 3, a polymerization area 4, a first confectioning area 5, a post-crosslinking area 6 as well as a further confectioning area 7, via at least one process parameter line 8, and at least one process value line 9. The individual areas and, when present, their sub-structures respectively may be connected via a process parameter line 8, and a process value line 9 with the computer 2.

In the educt area 3 depicted in FIG. 2, a water conduit controlled by a water conduit regulator 10, a sodium hydroxide conduit regulated by a sodium hydroxide conduit regulator 11, an acrylic acid conduit regulated via an acrylic acid conduit regulator 12, a crosslinker conduit regulated by a crosslinker conduit regulator 13, and a co-monomer conduit regulated by a co-monomer conduit regulator 14 lead into an educt mixer 15. By means of the regulators 10, 11, 12, 13, and 14, the respective amounts of water, sodium hydroxide, acrylic acid, crosslinker and optionally added co-monomer can be adjusted as process values. In the regulators 10, 11, 12, 13, and 14, or in the educt mixer 15, or in both, one or more probes 16 can be arranged, with which the states, in particular the temperature, can be determined as process parameters of the individual educt parts conducted to the educt mixer 15. Besides the temperature, the educt parts conducted to the educt mixer 15 respectively per time unit can be determined by means of an educt part flow meter 17 provided in the educt mixer 15, or in more educt part flow meters 17 provided in the respective regulators 10, 11, 12, 13, and 14, and in this way conclusions made regarding the concentration ratios present in the educt mixer 15, and thus in the educt mixture. An educt cooling 18 is attached to the educt mixer 15. This has a further educt sensor 16, with which in particular the temperature of the educt mixture flowing into the educt cooling 18 can be determined as process parameter. Furthermore, the educt cooling 18 comprises a cooling agent entry 19, and a cooling agent exit 20, whereby the amount of cooling agent per time, and the temperature of the cooling agent as process values regulate the cooling performance of the educt cooling 18. A gas exchanger 21 is attached to the educt cooling 18, which comprises a further educt probe 16, with which on the one hand the temperature of the educt mixture in the gas exchanger 21 can be determined as process parameter. Furthermore, the gas content, in particular the oxygen content in the educt mixture can be determined as further process parameter by means of the educt sensor 16. The determination of the gas bubble part by means of the density of the gassed educt mixture can likewise occur as further process parameter by means of the educt sensor 16. By means of a protecting gas regulator 22, the amount of protecting gas brought into the gas exchanger 21 can be regulated as process value. Furthermore, by means of the protecting gas regulator 22, in particular by regulating the gas outlet, the foam formation in the educt mixture can be adjusted.

In FIG. 3A is depicted a polymerization area 4 in the form of a trough belt polymerization device, which follows the educt area 3. The educt mixture coming from the gas exchanger 21 is conducted into a polymerization space 24 by means of an educt entry 23, monitored by means of an educt flow meter 26. This trough-like polymerization space 24 formed by a belt accepts furthermore polymerization initiating, accompanying catalysts, and additives into the educt mixture via a catalyst or additive entry 25 respectively, monitored by a catalyst flow meter 27. In the polymerization space 24, the polymerization reaction occurs to form a polymer 28, which is carried out from the polymerization space 24 on the one hand by the movement of the polymerization belt 31 forming the polymerization space 24 and on the other hand by a polymer conveyor 29 conveying the polymer 28 generated.

By means of one or more polymerization sensors 30 arranged above the polymerization space 24, the process parameters of the polymerization, in particular temperature and throughput, are determined. Besides the amount of educt mixture and the amount of added catalyst or additive respectively per time unit, the speed of the polymerization belt 31 in the movement direction 35 represent important process values of the polymerization step. The speed of the polymerization belt 31 is regulated by a drive 32 and a belt roller 34, upon which the polymerization belt 31 lies, and which is driven by a gear 33. Polymerization conveyor 29, polymerization belt 31, drive 32, gear 33, and belt roller 34 are housed in a holder 36. Further details concerning the design and carrying out of the polymerization area 4 by means of belt polymerization are given in, among others, DE 35 44 770 A1.

The FIGS. 3B and 3C show a further embodiment of a polymerization area 4 in the form of a knead reactor. Here, in educt entry 23 formed at a housing 39, monitored by an educt flow meter 26, the educt mixture is introduced into a polymerizations base 24 bordered by the housing 39. In exactly the same way, catalysts or additives are introduced into the polymerizations base 24 by means of an additive entry 25, monitored by a catalyst flow meter 27. The housing 39 comprises in the reaction space 24 a stirrer 37. Furthermore, the lower housing area bordering the reaction space 24 comprises a cooling 38. Below the stirrer 37 is arranged a screw-shaped polymer conveyor 29 for discharge of the polymer 28. The states relevant as process parameter of the polymerization device formed as a knead reactor are determined by means of one or more polymerization sensors arranged above or in the polymerization space 24. Further details concerning the polymerization area 4 formed as a knead reactor are given in, among others, U.S. Pat. No. 4,625,001 and EP 0 508 810 A1.

FIG. 3D shows a polymerization area 4 formed as a multiple screw extruder. In such a reactor, educt mixture and catalyst or additive are introduced comparably with FIGS. 3A, 3B and 3C, so that reference is here made to the details concerning these figures. In a housing 39, two or more screws 40 are housed, which extend along a longitudinal axis of the housing and are moved by means of a drive 42. In a section along an area of the transverse of the housing, the housing 39 encloses the screws 40 in form-locking fashion. The screws 40 comprise screw paddles 41, which reach into each other and have both a kneading and a conveying effect away from the educt entry 23. At the end of the housing lying opposite the educt entry is provided a polymer conveyor 29 formed as a screw for discharge of the polymer 28. With this multiple screw reactor, a process for continuous production of hydrophilic polymers can be carried out, wherein
(α) water-soluble, monoethylenically unsaturated monomers,
(β) from about 0.001 to about 5 mol. %, based upon the monomers (α1) at least two ethylenically unsaturated double bond-comprising monomers as crosslinker and
(γ) from about 0 to about 20 mol. %, based upon the monomers (α) water-insoluble monoethylenically unsaturated monomers in an about 20 to about 80 wt. % aqueous solution,
   in the presence of initiators, at temperatures within the range from 0 to 140° C., can be polymerized, wherein the aqueous solution of the monomers together with the initiator, and optionally an inert gas, are conducted continuously to a mix kneader with at least two axially parallel rotating shafts, wherein more than one knead and transport elements are located upon the shafts, which effect a conveying of the materials to be given at the start of the mix kneader in axial direction to the end of the mixer, wherein the part of heat removal by evaporation of water from the reaction mixture is at least about 5% of the reaction heat and the part of heat removal by product discharge is at least about 25% of the reaction heat and the remaining heat removal occurs by cooling the reactor walls.

The heat dissipation can be determined by means of one or more polymerization sensors 30, which are arranged either in or at the end of the polymerization space 24. By means of these polymerization sensors 30, suitable process parameters can be determined. Thus the heat dissipation can, for example, be determined by means of temperature measurements. As process values are considered, besides the screw speed, which can be adjusted via drive 42, also the position of the screw paddles 41, upon which the kneading and transport performance thereof is dependent. Further details concerning this form of the multiple screw reactor can be found, inter alia, in DE 199 55 861 A1. Further, suitable multiple screw extruders can be commercially obtained from the company List AG, Switzerland.

In FIG. 4 a first confectioning area 5 is shown, which is attached to the polymerization area 4 via a polymer entry 43. The first confectioning area comprises different sub-areas, wherein these are at least one comminution area 44, a drying area 45 subsequent thereto and a mill area 46 following the drying area. The comminution area 44 in turn comprises at least one cutter 47 for cutting the polymer 28, a grinder (“Wolf”) 48 following therefrom for tearing the comminuted polymer, and optionally a homogenizer 49, which is, for example, formed as a drum and leads to uniform distribution of the different hydrogel pieces coming out of the grinder. The comminution area 44 comprises at least one comminution sensor, by means of which the process parameters of the comminution area, in particular the temperature, the water content and optionally the compressibility of the hydrogel of the hydrophilic polymer located in the comminution area, or these parameters for the hydrogel leaving the comminution area, are determined. As process values of the comminution area 44 are considered in particular the energies introduced by means of the cutter 47 and the grinder 48 into the hydrogel. The cutting performance and the grinding performance, as well as the rotation speed of the drum are thus exemplary process values of the comminution step. Further details of the comminution device can be found for example in EP 0 827 443 A1. The drying area 45 following the comminution area 44 is, for example, formed as a zone circulating air dryer with different cells 52. In this dryer the hydrogel of the hydrophilic polymer coming out of the comminution area is led through the individual cells of the dryer by means of a conveyor belt 51, whose belt moves in movement direction 35, and substantially liberated from water by drying. In the dryer, in at least two, such as in at least each of the cells 52, can be provided respectively a drying sensor 76. As process values of the drying step are cited in particular the heat performance of the dryer and the belt speed of the conveyor belt 51. Particularly suitable driers are described in Modern Superabsorbent Polymer Technology F L Buchholz, A T Graham, Wiley-VCH, 1998, pages 87 ff. From the drying area 45 follows the mill area 46 which comprises at least one, such as at least two mills, such as a course mill 53 and a fine mill 54, which comprise respectively mill tools 55, wherein always two mill tools 55 form a mill gap 56. The mill gap 56 is larger for the course mill 53 than for the fine mill 54. The mill area 46 furthermore comprises at least one mill sensor 57 for determination of process parameters. As process parameters of the mill step are mentioned in particular the moisture content, the temperature and the particle or lump size of the product to be milled entering the mill area as dried hydrophilic polymer. A further group of process parameters is formed by the properties of the product to be milled leaving the mill area. As exemplary process values of the mill area 46 are mentioned in particular the speed of the mill tools 55 and the mill gap 56 of the individual mills. Further details concerning the mill step are found in Modern Superabsorbent Polymer Technology F L Buchholz, A T Graham, Wiley-VCH, 1998, pages 93 ff. The mill product leaving the mill area 46 via a mill outlet 58 enters via a mill inlet 59 into the post-crosslinking area 6.

FIG. 5 shows on the one hand the post-crosslinking area 6 and the optionally providable further confectioning area 7 following therefrom. By means of the milled product inlet 59 the particulate hydrophilic polymer now present as powder is initially intermediately stored in a reservoir 60. The reservoir 60 comprises a reservoir sensor 61, with which the moisture content, the temperature, and optionally the particle size of the hydrophilic polymer located in the reservoir 60 can be determined, for example. By means of an outlet regulator 62 regulated as process value, the hydrophilic polymer is introduced from the reservoir 60 into an additive mixer 65, into which furthermore, by means of a process value-regulated additive outlet regulator 64, an additive located in an additive tank 63, generally a post-crosslinker or a mixture of more than one post-crosslinkers, is likewise introduced into the additive mixer 65. The additive mixer 65 further comprises at least one additive mixer sensor 66 for determining the process parameters of the mixer. Such process parameters may be the temperature and the mixture ratios of the hydrophilic polymer and the additives in the additive mixer 65. To the additive mixer 65 is attached a dryer 67 which comprises at least one dryer sensor 68. Concerning the method of function of the dryer, reference is made to the details concerning the drying area 45.

The further confectioning area 7 attached to the post-crosslinking area 6 comprises an additive mixer 71, into which the hydrophilic polymer is introduced and to which a ripener 73 is attached. Into the additive mixer 71 is introduced from an additive tank 69, regulated by an additive outlet regulator by means of a process value at least one, for example more than two additives and not mixed with the hydrophilic polymer. By means of the additive mixer sensor 72, the process parameters of the additive mixer and the therein located mixture of additive and hydrophilic polymer are determined. These are in particular the moisture content and the temperature of this mixture. As process values of the additive mixer are mentioned in particular respectively the mixing or steering speed of the steering equipment in the mixer, which can, for example, be expressed by the so-called Froud number. The mixture obtained in the additive mixer 71 is subjected, in the ripener 73, which can for example likewise be a mixer or a dryer, to a ripening process which can be monitored by means of at least one ripening sensor 74 by corresponding process parameters, here in turn in particular the moisture and the temperature. Exemplary process values of the ripener 73 are, if it is a mixer, the speed of the mix aggregates. If the ripener 73 is a dryer, the above details for dryers are likewise valid. For the case that both the additive mixer 71 and the ripener 73 comprise mix aggregates, an exemplary process value is the ratio of the mix speeds of the respective steer or mixing aggregates in the additive mixer 71 and in the ripener 73 after the end of the further confectioning step the thus produced hydrophilic polymer is discharged via the product discharge 75 and filled into silos or other containers such as containers or big bags and transported away. Further details concerning the further confectioning step and in particular concerning the ripening can be taken from WO 2004/037900 A1.

### EXAMPLE 1

In a pilot plant installation corresponding to the above-described production device with a belt polymerization as polymerization area were collected over a time period of three months, 450 data sets respectively consisting in a line from a time-stamp for the throughput of the individual areas of the pilot plant installation, followed by individual values of the following detailed measurement points, and anotically determined physical, and chemical properties belonging thereto of the hydrophilic polymer, and thus an artificial neuronal network trained. For the training, the computer program Neuro Model 2.0 of the company Adlan-Tec was used. The automatic used guide was selected as modus. The prediction precision based upon the value area of the experience parameter as starting variable was below 10% after finishing the training. The thus-resulting model of an artificial neuronal network was thus sufficiently precise to calculate, for example, the experience parameter centrifuge retention (CRC) of hydrophilic polymers with sufficient precision. This model was coupled with the central control unit of the above described production device on the pilot plant scale. With delays often minutes, process parameters and process values from the process control system were automatically fed to the computer comprising the artificial neuronal network and the experience parameter to be expected for the CRC calculated therefrom to be 36.6 g/g. An analytical check of the CRC for the hydrophilic polymer produced according to this process by the above-described production device gave a value of 36.2 g/g.

Because of the calculation by the artificial neuronal network, in the present case the expenditure for analytical investigations could be reduced by about 30% compared to a production without the use of an artificial neuronal network. At the same time, the intervention rate as frequency of change of a process value in the production process was reduced by at least about 20%. Thus the number of process guidance corrections to be carried out by the operating personnel could be significant reduced.

### EXAMPLE 2

In this example, it was proceeded analogously to example 1, wherein the difference to example 1 consisted in using the artificial neuronal network for simulation of a plant change. The object was, starting from a CRC of 33.5 g/g, to set a CRC of 36 g/g, as far as possible without over and under-controlling of the production device. The change of the throughput amount of crosslinker was first input into the neuronal net, until this calculated a CRC of 36.0 g/g for a thus produced superabsorber. The crosslinker addition linked with the simulated CRC of 36.0 g/g was taken up in the production device and a superabsorber accordingly produced. An analytical check of the superabsorber showed a CRC of 36.2 g/g after the coming into effect of the change in crosslinker amount. Thus a rapid setting of the desired value was obtained without over- and under-controlling.

In the following are detailed the individual input measurement points of the polymer production.
1 temperature difference over cooler neutralization grade 1
2 temperature difference over cooler neutralization grade 2
3 flow rate water
4 flow rate aqueous 30% NaOH
5 flow rate acrylic acid neutralization rate 1
6 flow rate acrylic acid neutralization grade 2
7 flow rate crosslinker (polyethylene glycol diacrylate)
8 flow rate co-monomer (EMPEG-750-methacrylic acid ester)
9 temperature monomer tank
10 temperature monomer before polybelt
11 flow rate N₂ polybelt
12 entry monomer on polybelt
13 entry catalysis (redox initiator starter) on polybelt
19 entry additive (sodium carbonate) polybelt
20 temperature start polybelt
21 speed polybelt
22 temperature end polybelt
23 current consumption kneader, grinder, drum
24 belt speed in belt dryer
25 low pressure scrubber for air from the dryer
26 entry temperature scrubber
27 temperature supply air
28 temperature cell 2 of dryer
29 temperature cell 5 of dryer
30 temperature cell 7 of dryer
31 temperature cell 11 of dryer
32 current consumption course mill
33 current consumption fine mill
34 mill gap fine mill
35 control variable product discharge fine mill feed device (vibrator)
36 fill level pre product silo
37 temperature pre product
38 moisture pre product
39 throughput pre product
40 throughput additive (ethylene carbonate) I
41 rotational speed mixer
42 temperature paddle dryer section 1-4
43 temperature paddle dryer section 5-8
44 vapor entry temperature paddle dryer section 1-4
45 vapor entry temperature paddle dryer section 1-8
46 vapor entry pressure paddle dryer section 1-4
47 vapor entry pressure paddle dryer section 1-8
48 product temperature after post-crosslinking
49 throughput to mixer additive (polyethylene glycol 300)
50 current measurement mixer

FIG. 6 shows schematically an embodiment example of a further processing machine, namely a core machine 77, by means of which “cores”, that is, absorbent layers, for example, for baby diapers or sanitary napkins, are produced. Such core machines 77 can be wet laid, dry laid, spun laid, melt blown or air laid machines (cf. contribution from Dr. Edgar Herrmann to the EDANA 1997 NORDIC NONWOVENS SYMPOSIUM with the title Premanufactured Air laid Composites Containing Superabsorbents). The core machine 77 is controlled by means of a computer-generated model implemented upon a computer 2. In particular, the control is controlled by a corresponding neuronal network programmed on the computer 2. The core machine 77 can in particular be part of a machine for production of baby diapers, which are distributed by the company Famiccanica, Gdm, Diatec. Such a diaper machine is further described below with reference to FIG. 8. This machine for production of baby diapers is for example controlled by the same computer-generated model implemented on the computer 2 as the core machine 77. The relevant process parameters for the production device 1 are in particular the process parameters given above in connection with the production of a hydrophilic polymer. The process values relevant for the production device 1 are in particular the process values given above in connection with the production of a hydrophilic polymer.

The core machine 77 comprises, in one embodiment, a production device 1 for hydrophilic polymers. This production device 1 can in particular be controlled by means of a computer-generated model implemented upon the same computer 2, such as by the same computer-generated model. A conventional control for the production device 1 is also possible and in accord with the invention. In another embodiment, it is also possible that the production device 1 is controlled by means of a computer-generated model, while the core machine 77 as a part of the diaper machine 88 is conventionally controlled and/or regulated. The core machine 77 further comprises a fiber provision 78, in which fibers, in particular cellulose fibers, are made available. In particular, these fibers can be unwound or abraded from coils. In particular, these fibers can be present in pressed form on rollers and be unwound from these and defibrated by a hammer mill. The respective technique to be selected is determined inter alia by the fluff type. The fluff type thus represents a W process parameter. The fluff type is dependent upon the type used and its production. The fluff type is determined by measurement processes typical in the cellulose industry. The fibers represent a first further processing component in the sense of the present invention. The fibers are transferred to a mill 79 and there comminuted. The mill 79 can be a conventional mill, in particular a hammer mill. In the case of a hammer mill, this comprises a defibration gap, whose opening likewise represents a W process value, as well as the hammer type (material, hardness and/or design), sieve size and scale, which have an influence upon the W process parameters of the fibers. The W process parameters relevant for the mill 79 comprise in particular the fiber length distribution generated by the mill 79, the fiber lengths, the bulk density of the bulk product, the water content, fiber form (elongated or twisted) and/or the fill level of the mill 79 or of the fibers in the mill 79, restoring forces, torques and similar values affecting and/or concerning the mill 79 by means of the mill process. The W process parameters relevant for the preparation of the fibers 78, comprise in particular the moisture, form, bulk density and/or fiber length distribution of the fibers.

The milled fibers are brought via a first feed line 80 into a mixer 81, into which the hydrophilic polymer is also brought by means of a second feed line 82. In the mixer 81 the combination of the polymer with the fibers occurs. Relevant W process parameters in the mixer 81 are represented in particular by the air speed and/or turbulence in mixer 81, the added proportions of fibers and/or polymer, the water content in mixer 81, the dielectric constant and/or the adhesion or caking capacity of the mix. Relevant W process values comprise in particular the mix frequency, the increase or decrease of the addition of polymer and/or fibers, transport speeds of the polymer and/or of the fibers in the first 80 and/or the second feed line 82, etc.

The mix is fed from the mixer 81 via the conveyer line 83 to the core former 84. The core former comprises a former drum 85, which comprises, 86 as shown in detail schematically in FIG. 7, corresponding depressions, in which for example cores for diapers are formed. By rotation of the former drum 85, cores are formed in the depressions 86 for example by action of the centrifugal force or application of a reduced pressure. The core former 84 is operated in particular with low pressure, for example at pressures of less than about 500 mbar, such as less than about 100 mbar, in particular less than about 25 mbar, which represent corresponding W process parameters and are set by the vacuum as W process value by means of the pumps generating the reduced pressure.

The drive performance of a drive of the former drum 85, the performance of a vacuum pump for evacuating the core former 84, and/or the drive performance with which the mix, is conducted through the conveyer line 83. The core leaves the core former 84 through the core former exit line 87. The components 1, 78, 79, 81, and 85 shown in FIG. 6 are controlled by means of the computer-generated model implemented on computer 2. To this end, the model takes into account at least one neuronal network, the process parameters, and/or the W process parameters, and evaluates the process values and/or W process values by means of a store of experience. The data used serve in particular to adapt the store of experience for future control and regulation processes. The process parameters and W process parameters can be monitored by means of correspondingly formed probes which are not shown. The individual components 1, 78, 79, 81, 85 are connected with the computer 2 via signal and control feeds 91. By means of such a signal and control feed 91, for example both data from process parameter- or W process parameter-generating probes in the components 1, 78, 79, 81, and 85 can be transferred to the computer, where they can serve for example as input signal of the neuronal network. Furthermore, for example, corresponding control signals, which in the components 1, 78, 79, 81, and 85 lead to the alteration of a process value and/or of a W process value, can be transferred from the computer 2 to the components 1, 78, 79, 81, and 85. In particular, a multiplicity of signal and control lines 91 can be formed as a bus system, in which for each component 1, 78, 79, 81, and 85 a component-specific bus address is assigned. Furthermore, the signal and control lines 91 can be formed at least partially also in the form of a wireless network (Wireless LAN) optionally combined with a bus system.

FIG. 8 shows schematically a further processing machine, namely a diaper production machine 88, comprising a core machine 77. The cores produced in the core machine according to one of the claims 77 leave the core machine 77 via the core former exit line 87. In the web applier 89, the cores are provided with web, i.e. surrounded with thin webs (e.g. non-woven materials). These webs can be connected with each other and/or with the core, in particular connected definitively, in particular welded, or adhered, so that the web surrounds the cores, so that in particular the core is arranged substantially captive in a sheath. These thin webs are mostly materials which form an acquisition layer for uptake and transfer of aqueous body fluids such as urine and a distribution layer for uniform distribution of the aqueous body fluids upon the side of the diaper applied to the wearer. The transitions between the individual layers and the core have a significant influence upon the liquid management in the diaper or the feminine hygiene article (sanitary napkin). In this context, attention should be paid above all the distance between the layers (acquisition sheet followed by distribution sheet) and the core and to binding agents such as adhesives or glues. Thus for example the thickness of the construction obtained from the layers and the core as well as its mass per unit area and/or air permeability can be considered. The roller pressure and/or the amount of adhesive or glue influence this in turn. The cores provided with web are further processed in diaper former 90 to diapers. In diaper former 90, in particular outer plastic sheaths of the diaper are constructed, into which the core is moulded. Furthermore, various further additional elements are connected with the diaper, such as e.g. flexible hip bands, fasteners and/or flexible leg bands. Further details concerning construction and the method of function of a diaper machine can be found in inter alia the contribution of Dr. Edgar Herrmann at the EDANA 1997 NORDIC NONWOVENS SYMPOSIUM with the title Premanufactured Airlaid Composites Containing Superabsorbents.

Core former 77, web applicator 89, and diaper former 90 are connected via signal, and control lines 91 with the computer 2. The respective control or regulation of the components 77, 89, and 90 occurs by means of a computer-generated model, in particular a neuronal network, implemented on computer 2. In this way the relevant W process parameters, process parameters, W process values and/or process values are acquired and optionally adapted by means of the neuronal network. Relevant process parameters for the web applicator 89 are in particular the supply rate of the web, the amount, viscosity, temperature of adhesive, assembly conditions, etc. Relevant process parameters for the diaper former 90 are for example adhesive amounts, viscosities, temperatures, etc.

FIG. 9 shows schematically a paper machine 92, which comprises a headbox 93 followed by a water removal and drying area 94. In the headbox 93, a paper pulp is generated substantially from cellulose material, water and suitable additives such as flocculating agents and the like. These represent further processing components in the sense of the present invention. In the headbox 93 the addition of hydrophilic polymers occurs in a mixing area. These can be generated in particular in a production device 1. The polymer-comprising papers produced using such a paper machine 92 comprise in particular toilet, kitchen and/or care papers, as well as handkerchiefs.

According to another embodiment, the addition of the hydrophilic polymer can also occur in the paper pulp which is already applied flat for the removal of water. W process parameters relevant for paper production comprise in particular the length of the cellulose fibers and/or their length distribution, the water content of the paper pulp, the viscosity and/or temperature of the paper pulp, the present pH value, the size, and/or form of the polymer particles (polymer particles and/or polymer fibers) the size distribution of the polymer particles, swell and/or absorption rate of the polymer particles. W process values relevant for paper production comprise in particular the addition (amount and rate) of additives, for example flocculation, acidification agents or bases, the rate of removal of water, heating performance, and/or the pressure ratios in particular in the water removal and drying area, point of time and rate of addition of the polymer, the adjustable concentration ratios, in particular the polymer, fiber, water, and/or additive concentration, and their proportions. In general, the W process values and W process parameters in the incorporation of hydrophilic polymer in the production of hydrophilic polymer-comprising paper should be set such that the polymer absorbs as little water as possible during the production, so that the polymer-comprising paper after its production is as homogeneous as possible and has a large absorption and retention capacity.

The paper machine 92 and/or the production device 1 are controlled and/or regulated by means of a computer-generated model, in particular a corresponding neuronal network. The connection of the paper machine 92 and/or the production device 1 with a computer, on which the at least one computer-generated model is implemented, occurs via signal leads 91.

FIG. 10 shows schematically a fiber production device 95 for generating hydrophilic polymer-comprising cellulose fibers, as described among others in WO 03/012182 A1. In a spin preparation 96, for example cellulose pre-products, for example a substituted cellulose, in particular carboxymethylated cellulose, are digested (treatment with base and carbon disulfide) and made into a spin solution (cp. for example DE 28 09 312 A1). Into this spin solution are incorporated hydrophilic polymers, which can be produced in particular in a production device 1. The thus obtained spin solution is spun in a spin device 97 into fibers, which are post-treated in a fiber post-treatment unit 98, in particular washed and/or dried.

The cellulose pre-products as well as the digestion agents, solution agents and/or additives represent further processing components in the sense of the present invention The fiber production device 95 is, for example, respectively controlled or regulated by means of a computer-generated model which is implemented on computer 2. The W process parameters relevant for the spin preparation 96, the spin device 97, and the fiber post-treatment unit 98 comprise in particular the degree of substitution of the cellulose, the pH value, the temperature, and the concentration ratios such as for example the sulfur part or further concentrations of components of the spin solution and/or the viscosity of the spin solution, the size and/or form of the polymer particles (polymer particles and/or polymer fibers), the size distribution of the polymer particles, swell and/or absorption rate of the polymer partiles, the throughput rate, the mass flow rate and/ort he shearing at or through the spin nozzle, the degree of stretching and/or the yarn count or the fibers. The W process values relevant fort he spin preparation 96, the spin device 97, and the fiber post-treatment unit 98 comprise in particular the basifying and sulfidising of the spin solution, the spin pressure, the spin rate, the take-off rate of the fibers leaving the nozzle, heating performances, amount of an added washing agent, mix frequency, mixer geometry, mix time in particular of the addition of the hydrophilic polymer to the spin solution. The W process values are in particular set so that a uniform spin process is achieved, in which in particular the spin nozzle(s) do not clog and so that as homogeneous a distribution as possible of the hydrophilic polymer particles in the cellulose fiber is achieved.

A paper produced by the paper machine 92 shown in FIG. 9 and described above, and/or a fiber produced by the fiber production machine 95 shown in FIG. 10 and described above or a product comprising such fibers can, in particular in the production of cores and/or diapers, represent a further processing component in the sense of the present invention, and can be used in the core machine 77 and/or diaper machine 88. It is exemplary in this case that the neuronal networks of at least one of the further processing devices according to FIG. 9 or 10 communicate with the neuronal network controlling the diaper machine 88 or the core machine 77, in particular defined interfaces, for example at least one mutual neurone, are present or that a common neuronal network is present, which controls or regulates respectively at least two of the above described further processing machines 77, 88, 92, and 95 and/or production devices 1 and/or parts thereof.

List of Reference Characters

1 production device
2 computer
3 educt area
4 polymerization area
5 first confectioning area
6 post-crosslinking area
7 further confectioning area
8 process parameter line
9 process value line
10 water addition regulator
11 sodium hydroxide addition regulator
12 acrylic acid addition regulator
13 crosslinker addition regulator
14 co-monomer addition regulator
15 educt mixer
16 educt probe
17 educt partial flowmeter
18 educt cooling
19 cooling agent entry
20 cooling agent exit
21 gas exchanger
22 protective gas regulator
23 educt entry
24 polymerization space
25 catalyst or additive entry
26 educt flowmeter
27 catalyst flowmeter
28 polymer
29 polymer conveyor
30 polymerization sensor
31 polymerization band
32 drive
33 gear
34 belt roller
35 movement direction
36 holder
37 stirrer
38 cooling
39 housing
40 screws
41 screw paddle
42 drive
43 polymer entry
44 comminution area
45 drying area
46 mill area
47 cutter
48 grinder (“wolf”)
49 homogeniser
50 comminution sensor
51 conveyor belt
52 dry zones
53 course mill
54 fine mill
55 mill
56 mill gap
57 mill sensor
58 mill product exit
59 mill product entry
60 reservoir
61 reservoir sensor
62 exit regulator
63 additive tank
64 additive exit regulator
65 additive mixer
66 additive mixer sensor
67 dryer
68 dryer sensor
69 additive tank
70 additive exit regulator
71 additive mixer
72 additive mixer sensor
73 ripener
74 ripener sensor
75 product discharge
76 dryer sensor
77 core machine
78 fiber provision
79 mill
80 first supply line
81 mixer
82 second supply line
83 conveyor line
84 core former
85 former drum
86 depression
87 Core former exit line
88 diaper production machine
89 web applicator
90 diaper former
91 signal and control line
92 paper machine
93 headbox
94 water removal and drying area
95 fiber production device
96 spin preparation
97 spin device
98 fiber post-treatment unit

1. A process for producing a hydrophilic polymer in a production device, wherein a computer-generated model controls this production device.

2. The process according to claim 1, wherein the control occurs by determination of at least one process parameter and via at least one process value based upon the at least one process parameter.

3. The process according to claim 1, wherein the computer-generated model calculates the at least one process value.

4. The process according to claim 1, wherein this process occurs continuously.

5. The process according to claim 1, wherein the process is divided into at least two process steps.

6. The process according to claim 5, wherein in each of the at least two process steps, at least one step parameter is determined as a process parameter.

7. The process according to claim 6, wherein the at least one step parameter influences the at least one process value.

8. The process according to claim 5 with at least:
(a) an educt preparation step,
(b) a polymerization step,
(c) a first confectioning step,
(d) optionally a post-crosslinking step, and
(e) optionally a further confectioning step.

9. The process according to claim 1, wherein the control occurs by means of a store of experience assigned to at least one experience parameter.

10. The process according to claim 9, wherein the at least one experience parameter is at least one physical or chemical property of a hydrophilic polymer.

11. The process according to claim 10, wherein the experience parameter characterizes at least one property selected from:
P1 retention of an aqueous liquid,
P2 absorption of an aqueous liquid,
P3 absorption of an aqueous liquid against pressure,
P4 rate of absorption of an aqueous liquid,
P5 rate of absorption of an aqueous liquid against pressure,
P6 particle size distribution,
P7 residual monomer content,
P8 saline flow capacity,
P9 bulk density,
P10 pH value,
P11 flowability, and
P12 color.

12. The process according to claim 9, wherein the store of experience is manifested by the computer-generated model.

13. The process according to claim 9, wherein the store of experience is obtainable by a learning process.

14. The process according to claim 46, wherein the artificial neuronal network comprises at least one first artificial neurone and at least one further artificial neurone following the first artificial neurone.

15. The process according to claim 14, wherein in the first artificial neurone an input occurs by means of an input signal.

16. The process according to claim 14, wherein from the further artificial neurone an output occurs by means of an output signal.

17. The process according to claim 14, wherein the at least one process parameter correlates with at least one input signal of the first artificial neurone.

18. The process according to claim 14, wherein the at least one process value correlates with at least one output signal of the at least one further artificial neurone.

19. A prediction process for predetermining at least one of the following G values
G1 a G process parameter,
G2 a G process value,
G3 a G experience parameter,
in connection with a hydrophilic polymer or its production or both, comprising the following steps:
V1 operating a production of a hydrophilic polymer, thereby
V2 determining at least one of the V values
i. a V process parameter,
ii. a V process value,
iii. a V experience parameter,
V3 processing of the at least one V value in a data processing unit to form a store of experience in the form of a computer-generated model, and
V4 providing at least one G value based upon this store of experience.

20. The process according to claim 1, wherein at least one G value contributes to the control of the production device.

21. Composites, hygiene articles, fibers, sheets, foams, formed bodies, soil improvers, flocculation additives, paper additives, textile additives, water treatment additives, or leather additives comprising a hydrophilic polymer made by a process according to claim 1.

22. Use of a hydrophilic polymer obtainable by a process according to claim 1 in composites, hygiene articles, fibers, sheets, foams, formed bodies, soil improvers, flocculation additives, paper additives, textile additives, water treatment additives, or leather additives.

23. Use of an artificial neuronal network for determination of process values by means of a physical property of a hydrophilic polymer or of an absorbent composition comprising a hydrophilic polymer and at least one component different therefrom.

24. A process for producing a further processing product comprising a hydrophilic polymer in a further processing machine, comprising the process steps
providing
the hydrophilic polymer, and
at least one further processing component,
bringing into contact the hydrophilic polymer and the at least one further processing component to obtain a further processing product,
wherein a computer-generated model controls the further processing machine.

25. (canceled)

26. The process according to claim 47, wherein the computer-generated model of the production device and the computer-generated model of the further processing machine interact with each other.

27. The process according to claim 24, wherein the controlling occurs by determination of at least one W process parameter and by means of at least one W process value based upon this at least one W process parameter.

28. The process according to claim 24, wherein the computer-generated model calculates the at least one W process value.

29. The process according to claim 24, wherein this process occurs continuously.

30. The process according to claim 24, wherein in each of the at least two process steps respectively at least one W step parameter as W process parameter is determined.

31. The process according to claim 30, wherein the at least one W step parameter influences the at least one W process value.

32. The process according to claim 47, wherein the control occurs by means of a W store of experience assigned to at least one W experience parameter.

33. The process according to claim 32, wherein the at least one W experience parameter is at least one physical or chemical property of the further processing product.

34. The process according to claim 33, wherein the experience parameter characterizes at least one property selected from:
W1 Rewet,
W2 Leakage,
W3 Wicking,
W4 Absorption speed,
W5 Spreading of the liquid (“Spreading” in spread direction and area), and
W6 integrity in the dry or wet state.

35. The process according to claim 32, wherein the W store of experience is manifested through the computer-generated model.

36. The process according to claim 32, wherein the W store of experience is obtainable by means of a learning process.

37. The process according to claim 32, wherein the artificial neuronal network comprises at least one first artificial neurone and at least one further artificial neurone following the first artificial neurone.

38. The process according to claim 37, wherein in the first artificial neurone an input occurs by means of an input signal.

39. The process according to claim 37, wherein from the further artificial neurone an output occurs by means of an output signal.

40. The process according to claim 37, wherein the at least one W process parameter correlates with at least one input signal of the first artificial neurone.

41. The process according to claim 37, wherein the at least one W process value correlates with at least one output signal of the at least one further artificial neurone.

42. A prediction process for pre-determining at least one of the following WG values
WG1 a W process parameter or process parameter,
WG2 a W process value or process value,
WG3 a W experience parameter or experience parameter,
in connection with a hydrophilic polymer and/or a further processing product or production thereof or both, comprising the following steps:
V1 operating a production of a further processing product, thereby
V2 determining at least one of the WV values
i. a WV process parameter,
ii. a WV process value,
iii. a WV experience parameter,
V3 processing of the at least one WV value in a data processing unit to form a store of experience in the form of a computer-generated model,
V4 providing at least one WG value based upon this store of experience.

43. A prediction process for pre-determination of at least one of the following WG values
WG1 a W process parameter or process parameter,
WG2 a W process value or process value,
WG3 a W experience parameter or experience parameter,
in connection with a hydrophilic polymer and/or a further processing product or its production or both, wherein at least one WG value based upon an available store of experience is provided.

44. The process according to claim 24, wherein the further processing machine is a fiber spinning, fiber matrix, paper, core, wound dressing or diaper machine.

45. The process according to claim 24, wherein the further processing product is fibers, fiber matrices, paper, cores, wound dressings or diapers.

46. The process of claim 1, wherein the computer-generated model is an artificial neuronal network.

47. The process of claim 24, wherein the computer-generated model is an artificial neuronal network.
